(19) United States
(12) Patent Application Publication
(10) Pub. No.: US 2007/0093243 A1
(43) Pub. Date: Apr. 26, 2007

(54) DEVICE MANAGEMENT SYSTEM

(76) Inventors: Vivek Kapadekar, Laguna Niguel, CA (US); Sunil Marolia, Laguna Niguel, CA (US); Bindu Rama Rao, Laguna Niguel, CA (US)

Correspondence Address: MCANDREWS HELD & MALLOY, LTD, 500 WEST MADISON STREET, SUITE 3400, CHICAGO, IL, 60661, US

(21) Appl. No.: 11/552,942

(22) Filed: Oct. 25, 2006

Related U.S. Application Data
(60) Provisional application No. 60/730,286, filed on Oct. 25, 2005.

(51) Int. Cl. H04M 3/00

(52) U.S. Cl. 455/419; 707/8

(57) ABSTRACT

A device management system enables management of firmware, provisioning, and configuration information updates to of a plurality of mobile electronic devices via a wireless communication network. A user self-care interface allows subscribers to interact with the device management system to identify problems in the mobile electronic devices, and to schedule updates, via a web-based interface. Delivery of updates to the mobile electronic devices is managed so as to maintain device management system loading at acceptable levels, within scheduling constraints.

### RELATED APPLICATIONS

The present application makes reference to, claims priority to, and claims benefit of U.S. Provisional Patent Application Ser. No. 60/730,286 entitled “DEVICE MANAGEMENT NETWORK” (Attorney Docket No. 101USMD101), filed Oct. 25, 2005, the complete subject matter of which is hereby incorporated herein by reference, in its entirety.

The present application makes reference to PCT Application with publication number WO/02/41147 A1, PCT number PCT/US01/44034, filed Nov. 19, 2001, and to U.S. Provisional Patent Application Ser. No. 60/249,606, filed Nov. 17, 2000, the complete subject matter of each of which is hereby incorporated herein by reference, in its entirety.

The present application also makes reference to U.S. Provisional Patent Application Ser. No. 60/664,249, entitled “DEVICE CLIENT SPECIFICATION” (Attorney Docket No. 101USMD117), filed on Mar. 21, 2005, to U.S. patent application Ser. No. 11/385,162, entitled “MOBILE DEVICE CLIENT” (Attorney Docket No. 16639US02), filed Mar. 21, 2006, to U.S. Provisional Patent Application Ser. No. 60/652,457, entitled “NETWORK FOR CUSTOMER CARE AND DISTRIBUTION OF FIRMWARE AND SOFTWARE UPDATES” (Attorney Docket No. 101USMD111), filed Feb. 11, 2004, to U.S. patent application Ser. No. 11/352,702, entitled “NETWORK FOR CUSTOMER CARE AND DISTRIBUTION OF FIRMWARE AND SOFTWARE UPDATES” (Attorney Docket No. 16554US02), filed Feb. 13, 2006, the complete subject matter of each of which is hereby incorporated herein by reference, in its entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. If firmware or firmware components are to be changed in electronic devices, it is often very tricky to update the firmware components.

It is often difficult to determine what is wrong with a device when a problem is encountered. Quite often, a customer care representative for an operator does not have answers to a customer's problem and is not able to fix it. Determination of problems with a customer's mobile device is a big problem for operators. Answering customer care calls is quite expensive. Especially so if at the end of such a call, the customer care representative is unable to determine what is wrong with the device.

Different devices have different set of resources, different sets of parameters, etc. Managing mobile devices in a heterogeneous network is a huge problem. Figuring out what parameters need to be set is also a problem.

Customer care centers get numerous calls for support from customers. They have very few means to determine what is wrong with a device. The Customer Care Representative (CCR) often asks questions of a customer, but they do not get proper answers. Customers often do not know what is wrong with their device. Thus, configuration changes that can fix a problem cannot be easily determined. Again, firmware updates that can fix the problem cannot be identified.

Quite often, even when a problem is diagnosed, a solution may not be available. Thus, customers who call to report a problem go away without having solved it. Each call to a customer care center typically takes several minutes and often a customer waits in a “queue” until a CCR becomes free to take his call—the next few minutes are then spent just asking questions and collecting device and customer information, etc. Thus, customer care calls can take over 20 minutes even when a problem cannot be determined or a solution provided.

If an operator needs to handle millions of customer care calls, such as when a firmware bug exists in a new device, it will be very expensive and take a lot of resources to handle the customer care calls.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method supporting management of updating of firmware and parameters in a plurality of mobile electronic devices via a communication network, substantially as shown in and/or described in connection with at least one of the figures, as set forth more completely in the claims.

### BRIEF DESCRIPTION OF SEVERAL VIEWS OF THE DRAWINGS

FIG. 1 shows a communication network supporting management of an electronic device served via a wireless infrastructure, in which a representative embodiment of the present invention may be practiced.

FIG. 2 is a perspective block diagram of an exemplary network that is capable of diagnosing problems within a electronic device that may correspond to, for example, the electronic device of FIG. 1, and of disseminating solutions based on a dissemination policy, in accordance with a representative embodiment of the present invention.

FIG. 3 is a block diagram illustrating exemplary interfaces of a device management web services interface (DMWSI) with scheduling support for a device management server, in accordance with a representative embodiment of the present invention.

FIG. 4 is a block diagram illustrating exemplary interfaces of a device management web services interface (DMWSI) with for a diagnostics server or a customer care server, in accordance with a representative embodiment of the present invention.

FIG. 5A is an exemplary user interface bulk configuration screen showing system wide parameters, in accordance with a representative embodiment of the present invention.

FIG. 5B is another exemplary user interface bulk configuration screen showing system wide parameters, in accordance with a representative embodiment of the present invention.

FIG. 6A is an exemplary user interface screen showing parameters and actions supporting both individual device bootstrap requests as well as bulk bootstrap operations, in accordance with a representative embodiment of the present invention.

FIG. 6B is an exemplary user interface bulk selection detail screen showing selected target details, in accordance with a representative embodiment of the present invention. A representative embodiment of the present invention may allow review but not selection of individual targets.

FIG. 7A is an exemplary user interface bulk selection screen supporting the creation, exporting and importing of collections of mobile devices to be updated, in accordance with a representative embodiment of the present invention.

FIG. 7B is another exemplary user interface bulk selection screen that may be used in selecting devices for bulk queries and updates that supports the creation, exporting and importing of collections of mobile devices to be updated, in accordance with a representative embodiment of the present invention.

FIG. 7C is another exemplary user interface bulk selection screen that may be used in selecting devices for bulk queries and updates that supports the creation, exporting and importing of collections of mobile devices to be updated, in accordance with a representative embodiment of the present invention.

FIG. 8A is an exemplary user interface bulk selection detail screen providing detailed device information for the device categories shown in FIGS. 7A, 7B, 7C supporting the creation, exporting and importing of collections of devices to be updated, in accordance with a representative embodiment of the present invention.

FIG. 8B is another exemplary user interface bulk selection detail screen providing detailed device information for the device categories shown in FIGS. 7A and 7B supporting the creation, exporting and importing of collections of devices to be updated, in accordance with a representative embodiment of the present invention.

FIG. 9A is an exemplary user interface screen supporting bulk job deployment, in accordance with a representative embodiment of the present invention.

FIG. 9B is another exemplary user interface screen supporting bulk job deployment, in accordance with a representative embodiment of the present invention.

FIG. 9C is an exemplary user interface screen supporting confirmation of bulk job submission, in accordance with a representative embodiment of the present invention.

FIG. 10 is an illustration of an exemplary rate plan table specifying the activation rate for a rate lane for every hour of a week, in accordance with a representative embodiment of the present invention.

FIG. 11 is an illustration of an exemplary exception list that may be associated with the rate plan table of FIG. 1, in accordance with a representative embodiment of the present invention.

FIGS. 12A and 12B illustrate two views of an exemplary user interface bulk job summary report screen showing a summary report of current bulk jobs, in accordance with a representative embodiment of the present invention.

FIG. 12C illustrates an exemplary user interface bulk job details screen showing the details of a single bulk job, in accordance with a representative embodiment of the present invention.

FIG. 13 is an exemplary user interface job detail screen showing job detail information including status for each device/task associated with a bulk job, in accordance with a representative embodiment of the present invention.

FIG. 14A is an exemplary user interface screen showing device detail information for a specific device shown on the job detail screen of FIG. 13, in accordance with a representative embodiment of the present invention.

FIG. 14B is another exemplary user interface task details screen showing device detail information for a specific mobile device, in accordance with a representative embodiment of the present invention.

FIG. 15 illustrates an exemplary architecture of a device management system in accordance with a representative embodiment of the present invention.

FIG. 16 is a block diagram illustrating an exemplary set of system entities that may be involved in the activation and management of tasks of a job, in accordance with a representative embodiment of the present invention.

FIG. 17 shows a block diagram illustrating an exemplary set of major components and interfaces of a device management system in accordance with a representative embodiment of the present invention.

FIG. 18 is a block diagram illustrating an exemplary set of the principal properties of each object and the inter-relationship between objects, in accordance with a representative embodiment of the present invention.

FIG. 19 is a block diagram that illustrates deployment, reporting and configuration components of an exemplary device management server engine, in accordance with a representative embodiment of the present invention.

FIG. 20 is a block diagram that illustrates the principal functions of each component of an exemplary device client, and the flow among the principal components, in accordance with a representative embodiment of the present invention.

### DETAILED DESCRIPTION OF THE INVENTION

Aspects of the present invention relate to systems and methods for managing electronic devices in a device management network. More specifically, aspects of the present invention relate to the management of firmware and parameter initialization and update in a plurality of mobile electronic devices via a wireless communication network.

The following discussion describes various embodiments of the present invention as applied to a mobile device which may comprise, for example, a mobile phone, cellular telephone, and personal digital assistant (PDA). The specific mobile device examples provided herein are for purposes of illustration, and do represent specific limitations of the present invention. Embodiments of the present invention may have application in the management of a wide variety of portable/handheld electronic devices having a processor, memory, a display, a means of user input, and communications capabilities via wired or wireless networks.

Although many of the operations described here are illustrated in terms of specific prototype screen shots, a representative embodiment of the present invention may, for example, provide equivalent services through simple object access protocol (SOAP) application program interfaces (APIs).

A representative embodiment of the present invention provides reporting and tools to allow for FOTA administrators to track the ongoing update process and easily diagnose the root causes of any unsuccessful mobile device updates.

The following acronyms and abbreviations may be used herein.

TABLE 1
Acronyms and Abbreviations

| | |
|---|---|
| API | Application Programming Interface |
| DL | Download |
| DM | Device Management |
| ESN | Electronic Serial Number, the device ID within a CDMA or |
| | TDMA network. |
| GUI | Graphics User Interface. |
| IMEI | International Device Equipment Identity, the device ID within |
| | a GSM network. |
| Bulk Job | A single bulk operation, typically involving a potentially large |
| or Job | number of specified devices. Each device within a bulk job is |
| | ultimately serviced by a “task”. |
| LDAP | Light-weight Directory Access Protocol |
| MMV | Manufacturer, Model, and Version |
| MSISDN | Originally “Mobile Station Integrated Services Digital |
| | Network”, but more commonly defined as “mobile phone |
| | number on a GSM network”. |
| OMA | Open Mobile Alliance |
| PKG#1 | The first OMA DM message from a device attempting to |
| | initiate a new OMA DM session |
| SMS | Short Message Service |
| SMSC | Short Message Service Center - distributes SMS messages and |
| | reports status on status such as deliver receipts, errors, and |
| | message expiration. |
| SOAP | Simple Object Access Protocol - used for all externally |
| | accessible API's |
| Task | An operation on a single mobile device. The life of a task may |
| | start when the task is entered into the active state and may end |
| | when the update of the device is completely, or the tasks fails |
| | due to an unrecoverable error (or exhausted retry count). |

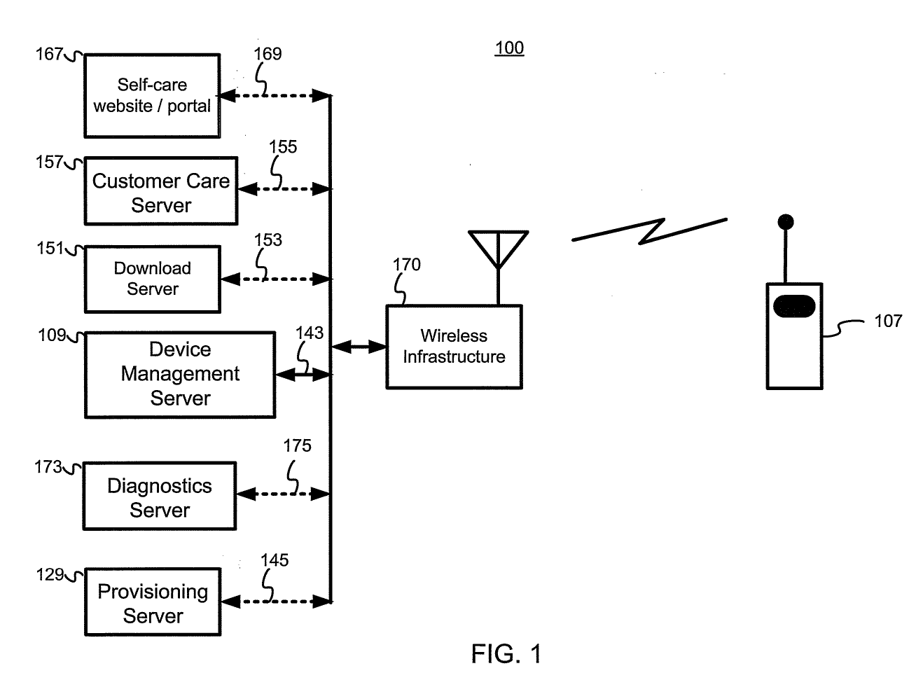

FIG. 1 shows a communication network 100 supporting management of an electronic device 107 served via a wireless infrastructure 170, in which a representative embodiment of the present invention may be practiced. The communication network 100 comprises a customer care server 157 communicatively coupled to the wireless infrastructure 170 via a communication path 155. The customer care server 157 may support the activities of a customer care representative (not shown) using, for example, a dedicated terminal device, or a personal computer having appropriate application software. The communication path 155 may comprise a dedicated wired or wireless communication link such as, for example, an intranet, the Internet, a wired or wireless local area network, a packet network, or any other suitable form of communication link. The communication network 100 may also comprise a self-care website/portal 167 communicatively coupled to the wireless infrastructure 170. The self-care website/portal 167 may permit a subscriber having electronic device 107 to diagnose, provision, and update the electronic device 107 via, for example, a wired or wireless communication path 169 that may include, for example, any of the communication means described above with respect to communication path 155.

The communication network 100 also comprises a provisioning server 129, that may also be referred to herein as a “broadcast server”, and a device management (DM) server 109 that may support, for example, an Open Mobile Alliance (OMA) device management (DM) protocol, or a proprietary protocol. The communication network 100 also comprises a download server 151 for downloading update packages to the electronic device 107. In a representative embodiment of the present invention, an update package may, among other things, comprise a set of instructions executable by an update agent (not shown) in the electronic device 107 to convert or transform an existing version of software and/or firmware code to an updated version.

As shown in the illustration of FIG. 1, the self-care website/portal 167, the customer care server 157, the provisioning server 129, a DM server 109, a diagnostics server 173 and the download server 151 may be communicatively coupled via respective communication paths 169, 155, 145, 143, 175, and 153 to the wireless infrastructure 170. Although shown as separate entities, the self-care website/portal 167, the customer care server 157, the provisioning server 129, the DM server 109, the diagnostics server 173 and the download server 151 may reside on a single server, or on multiple servers co-located or separately located, depending upon anticipated load, economics, server capability, etc. The communication paths 169, 145, 143, 175 and 153 may comprise any of the communication links described above with respect to the communication path 155. The wireless infrastructure 170, in a representative embodiment of the present invention may comprise, for example, a cellular network, a paging network, a wireless local and/or wide area network, or other suitable wireless communication network. Although the wireless infrastructure 170 is shown as a single entity having a single antenna location, this does not represent a specific limitation of the present invention. A representative embodiment of the present invention may comprise a greater number of antenna locations including those belonging to separate services providers, without departing from the scope of the present invention.

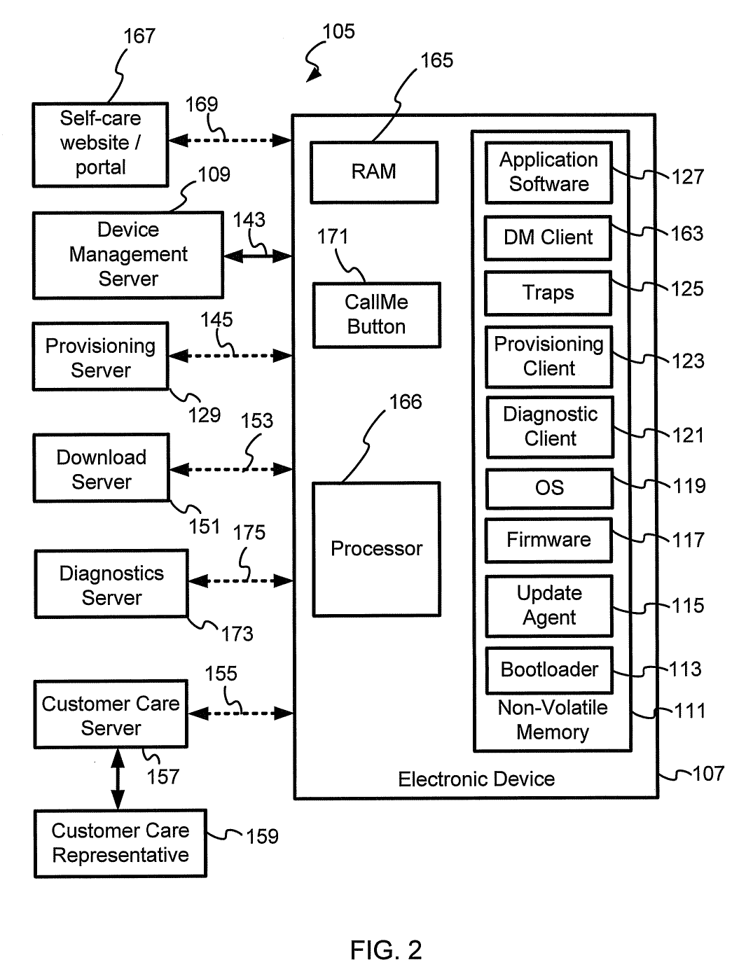

FIG. 2 is a perspective block diagram of a device management system 105 that supports remote diagnostics, remote management, 3rd party management, software component management, service enablement, scheduling of management operations and firmware updates, in accordance with the present invention.

A device management system in accordance with the present invention, such as, for example, the device management system 105 of FIG. 2, may comprise a device management (DM) server 109, an external system such as a customer care server 157, a diagnostics server 151, a mobile device 107 and a provisioning server 129. The mobile device 107 may, for example, comprise a mobile phone, a cellular telephone, a pager, and a personal digital assistant, and may be capable of updating an application software 127, an operating system (OS) 119, or a firmware 117 in the mobile device 107, employing an update package delivered by the diagnostics server 151. The device management system 105 is capable of supporting device management of multiple mobile devices and diagnosing any problems in those mobile devices in order to find an appropriate solution. It is also capable of receiving provisioning information from the customer care server 157 or the provisioning server 129 to fix configuration problems or reconfigure software and hardware. The mobile device 107 is capable of applying updates using one or more update agents 115 that are each capable of processing update packages or subsets thereof. Such an update package may be stored on a server, and may comprise a set of instructions executable by an update agent resident in the mobile device 107, such as the update agent 115. The set of executable instructions may cause the update agent 115 in the mobile device 107 to transform or convert a first version of code located in RAM 165 or in non-volatile memory 111, to a second version of code.

If a management operation needs to be invoked by the diagnostics server 151 or the customer care server 157, a web services interface (WSI) is used for that purpose. An associated schedule may be provided along with the management operation. Otherwise, optionally, one may be provided by the DM server 109. If the DM server 109 provides a schedule, then it is communicated to the external system such as the diagnostics server 151 or the customer care server 157. In addition, the schedule provided by the diagnostics server 151 or the customer care server 157 for a management operation (or a management task, or set of tasks, in general) may be modified or an alternative schedule selected or computed by the DM server 109. Such modified or alternative schedule is optionally communicated back to the diagnostics server 151 or the customer care server 157, such as via the WSI.

In one embodiment, if a bulk operation is initiated by an external system with the DM server 109, the DM server 109 returns a set of schedules, one for each target device for the bulk operations. The WSI employed for submitting the bulk operation would facilitate specification of a list of target devices for the bulk operation along with a list of schedules. If a list of schedules is not presented to the DM server 109 along with the bulk operation (and the list of target devices, for example), the DM server can generate or compute schedules for those devices (to conduct the associated operation). The generated or computed schedules are used by the DMS to conduct the operation on the associated target mobile devices. In addition, the generated or computed schedules can be retrieved, if necessary, by the external system from the DM server 109. Again, in a related embodiment, the generated or computed schedules are returned to the external system as a response, when the bulk operation is communicated (along with the list of target devices, and perhaps even with proposed schedules) to the DM server 109 by the external system.

The dashed communication means 169, 153, 145 and 155 represent web services interface (WSI) in one embodiment of the present invention, wherein the DM server 109 provides the WSI. Other means of communication are also contemplated.

The mobile device 107 is capable of receiving update packages. It comprises the update agent(s) 115 that is capable of updating the mobile device 107, a diagnostic client 121 that facilitates remote diagnosis and a traps client 125 that facilitates setting traps and retrieving collected information. The mobile device 107 also comprises a DM client 163 that is capable of interacting with the provisioning client 123, the diagnostic client 121 and the traps client 125. The DM client 163 typically received DM commands from the DM server 109 and implements them. The diagnostics server 151 is used to download firmware and software updates.

The customer care server 157 facilitates access to the information in the device by customer care representatives (CCR). When a CCR needs to diagnose a problem with a device, the CCR can retrieve various configuration values, parameters, etc. from a device 107 one at a time. Instead, in accordance with the present invention, the CCR is also able to retrieve a device profile that provides a large set of information from the device comprising a hardware profile, a software profile, a configuration profile, a memory profile, a subscriber profile, a localization profile, a connectivity profile, etc. In addition, the device is capable of communicating the device profile automatically to the customer care server 157 when a customer/subscriber activates a CallMe button 171 on the device to automatically register for a customer care service.

Automatic registration by the customer for service would make it unnecessary for the customer to dial into a customer care service (often using a special dial-in number) and spend several minutes waiting for a CCR to become free to handle the call. It also automatically provides device and subscriber information to the CCR by means of the device profile communicated to the customer care server 157, thereby making it unnecessary for the CCR to ask several questions and spend several minutes just to determine device particulars and determine a profile of firmware and applications on the device.

Thus, instead of employing several different individual DM sessions (or other sessions) during, or subsequent to, a call to a customer care representative by a customer of the device 107, the present invention makes it possible to retrieve this set of information, the device profile, and make it available to the CCR (ahead of time). In addition, the device profile may be communicated to the customer care server 157 in one single session, for example, in one single package, by the device 107 when the CallMe button (or some other button with the same functionality assigned to it) is invoked. In one embodiment, the device profile is retrieved by the DM client 163 and communicated to the customer care server 157 via the DM server 109. In another embodiment, it is communicated over an SMS means available to the device 107.

When a CCR receives a call from the user of the mobile device 107 for customer care service, the customer care server 157 automatically retrieves the device profile stored in the customer care server 157 and makes it available to the CCR, such as on a display (or PC) used by the CCR. In a related embodiment, if the device profile is not available in the customer care server 157, it is retrieved from a self-care website/portal 169, or from alternative databases.

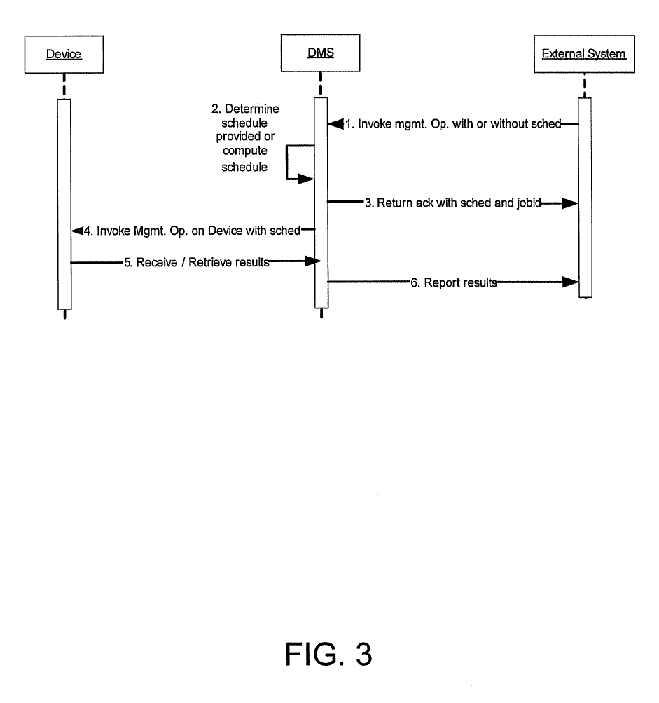

FIG. 3 is a block diagram illustrating exemplary interfaces of a device management web services interface (DMWSI) with scheduling support for a device management server, in accordance with a representative embodiment of the present invention.

The WSI interfaces may be used by an external system for invoking management operations with or without an associated schedule. This provides the ability to send schedule information along with the management operation details across the DMWSI interface. The following description makes reference to the elements of FIG. 2. As shown in the illustration of FIG. 3, the following actions may occur. In step 1, an external system may invoke a management operation with or without an optional schedule. If an optional schedule is provided, a device management server (DMS) such as the DM server of FIG. 2 may be expected to use it. In step 2, the DMS may determine if a schedule has been provided and may employ one if one is provided. Otherwise the DM server may compute a schedule. In step 3, The DMS may return an acknowledgement message to the external system along with the computed schedule, or a determined schedule, and a jobid that may be used for subsequent tracking. In step 4, the DMS may invoke the management operation on a device with the schedule information. In step 5, the device may return the results, or the DMS may retrieve the results from the device. In step 6, the DMS may report the results to the external system using the DMWSI (via an appropriate DMWSI interface) employing the jobid.

In a representative embodiment of the present invention, an external system may specify management operations with an associated schedule, and a DMS may compute a schedule for a management operation invoked by an external system, if one is not provided by the external system. The DMS may report the computed schedule, and may provide a jobid to the external system for tracking purposes. The DMS may report results for management operations scheduled by an external system.

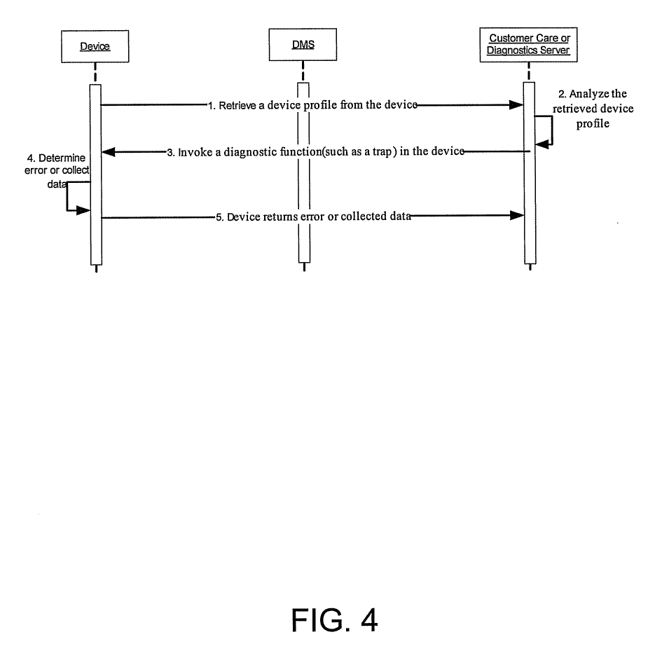

FIG. 4 is a block diagram illustrating exemplary interfaces of a device management web services interface (DMWSI) for a diagnostics server or a customer care server, in accordance with a representative embodiment of the present invention. The following describes the steps of the exemplary series of actions of FIG. 4. In step 1, a customer care or diagnostics server, which may be an external system to the DMS may retrieve (e.g., via the DM server) a device profile from a mobile device. The device profile retrieved may, for example, be “brief”, “regular” or “detailed”. In step 2, the diagnostics server may analyze the retrieved device profile. In step 3, the diagnostics server may invokes a diagnostic function (e.g., a trap) in the mobile device to collect data. In step 4, the mobile device may return an error, if it does not support the requested diagnostics function. Otherwise, the mobile device may collect the requested data. In step 5, the mobile device may report the collected data to the diagnostics or customer care server via the DM server via an appropriate DMWSI interface. In a representative embodiment of the present invention, an external diagnostic server may conduct remote diagnostics. The external system may receive a mobile device profile from the mobile device in response to a request from the external system. It may be possible to invoke a diagnostic function or a diagnostic procedure in the mobile device to collect data, and the DM server or external system determine which diagnostic function or diagnostic procedure may be invoked in the device to collect data. The mobile device may report the collected data to an external system, such as a diagnostics server or customer care server.

A representative embodiment of the present invention may employ a user interface comprising a number of screens use to convey and permit entry of information related to the operations of a device management system. Such user interface screens may permit a system user to, for example:
Select the mobile devices to be updated in bulk
Optionally—to view, import, and export information for selected mobile devices
Set parameters (date, time, rate) and submit a bulk job
Confirm the bulk job—approve any exceptions
Track status across all bulk jobs
View status for a specific bulk job—all tasks in the job
View event details for a specific task
Configure system wide bulk resource controls

The above list of possible uses is not intended to be exhaustive, and a greater or lesser number, or different user interface screens may be employed without departing from the spirit and scope of the present invention.

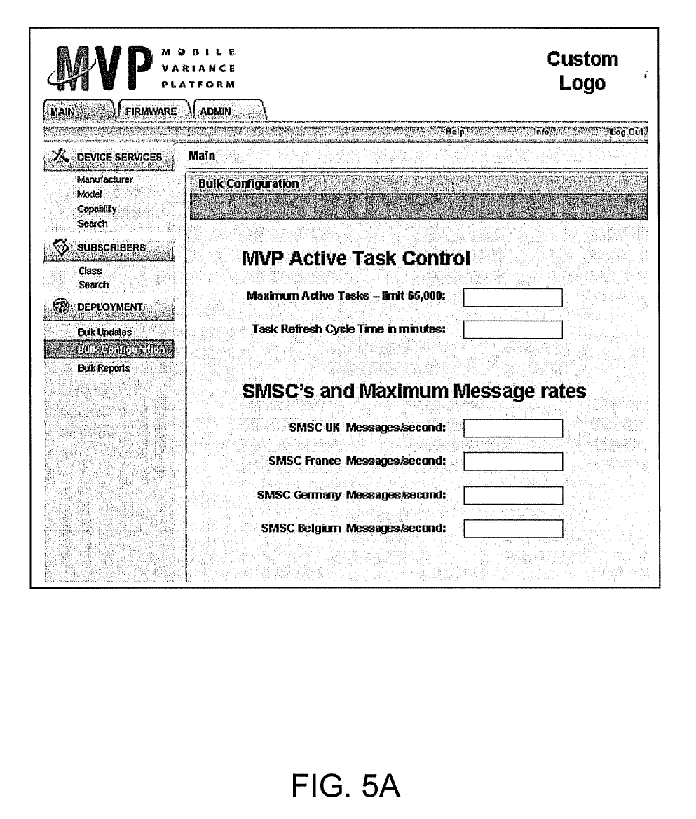

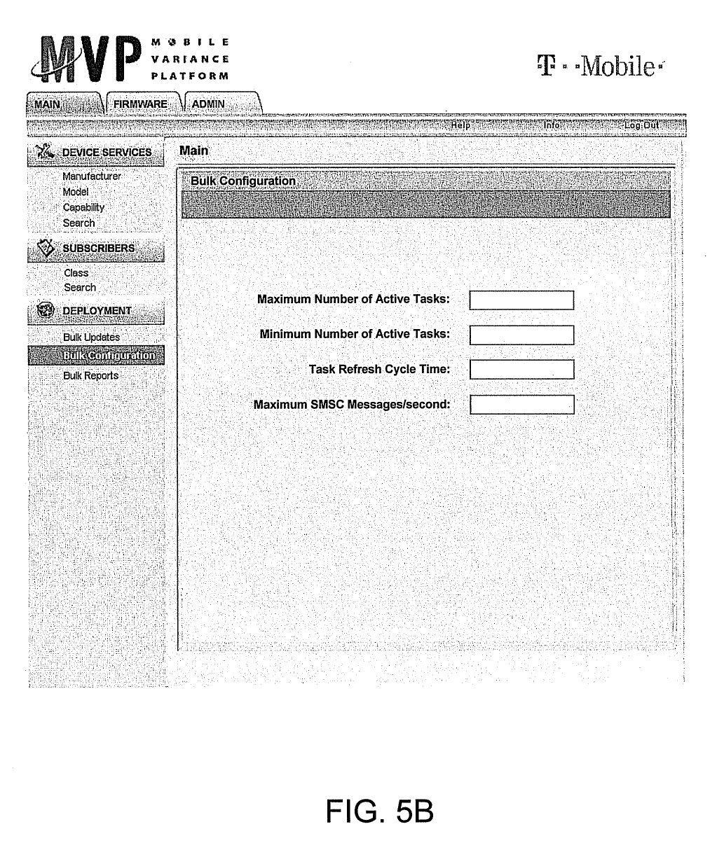

FIG. 5A is an exemplary user interface bulk configuration screen showing system wide parameters, in accordance with a representative embodiment of the present invention. Note that although a device management server in a representative embodiment of the present invention may be located at a central location, the DM server may access more than one short message service center (SMSC) for bootstrap and notification operations. In the example screen shown in FIG. 5A, four “regional” SMSCs are referenced, using SMSC information maintained elsewhere within the device management server. In a representative embodiment of the present invention, the information shown in FIG. 5 may be combined with information from the UI's used to define and manage regional user groups. A representative embodiment of the present invention may support the setting of system wide capacity limits. These limits help to assure that the overall capacity of the system, the SMSCs, and the network may not be exceeded by misuse of bulk operations or services.

The purpose and function of each of the parameters shown in FIG. 5A is now explained. Although a representative embodiment of the present invention has no inherent architectural limit on the number of active tasks, the same may not be true for a carrier's network. Thus, the bulk service may employ a user settable value that controls the maximum number of active tasks, i.e., the maximum number of tasks permitted to be active on the carrier's network at one time. A default value may be established for a small pilot system, requiring specific user action (and thought) before raising this value for larger installations. An exemplary default for this value may be 5000. Due to limits on the size of the session ID in the OMA DM Notification message format (8-bits), the upper limit on this value is 65K.

A representative embodiment of the present invention may maintain a time value, in minutes, that controls how often pending tasks are reviewed for possible activation. An exemplary value may be five minutes, which may guarantee that pending jobs will be reassessed for activation at least every five minutes. A default for this value may be five minutes.

A representative embodiment of the present invention may enforce an absolute maximum on the number of SMSC messages sent over a period of one second for each SMSC to be used. This number may be enforced using an SMSC gateway such as Kannel. However, a representative embodiment of the present invention may enforce an equivalent limit at the “per minute” level (i.e., 20 per second equated to 1200 per minute) if SMSC gateway control is unavailable for a given carrier configuration.

A representative embodiment of the present invention may support the concept of regional SMSCs as shown in FIG. 5A, above. Each SMSC may be assigned to one or more “MSISDN prefix codes” (e.g., a country code), and provided with a user friendly name for easy access.

Most carriers are expected to order handsets that have been specifically pre-provisioned for the carrier's network. However, it is often necessary to bootstrap one or more handsets to support smaller customer “trials” and other inevitable exceptions, such as the need to support devices not purchased directly from the carrier. The following prototype screen shows how MVP can support both individual device bootstrap requests as well as bulk bootstrap operations

A representative embodiment of the present invention may support bulk device management operations upon mobile devices. Bulk device management operations may also be referred to herein as bulk campaign management. Bulk update operations may be performed by a firmware over-the-air (FOTA) administrator of “FOTA Administrator”. Such bulk operations, each supported by one or more user interface screens, are detailed in later sections of this application.

FIG. 5B is another exemplary user interface bulk configuration screen showing system wide parameters, in accordance with a representative embodiment of the present invention. FIG. 5B is similar to the screen illustrated in FIG. 5A, but has fewer parameters.

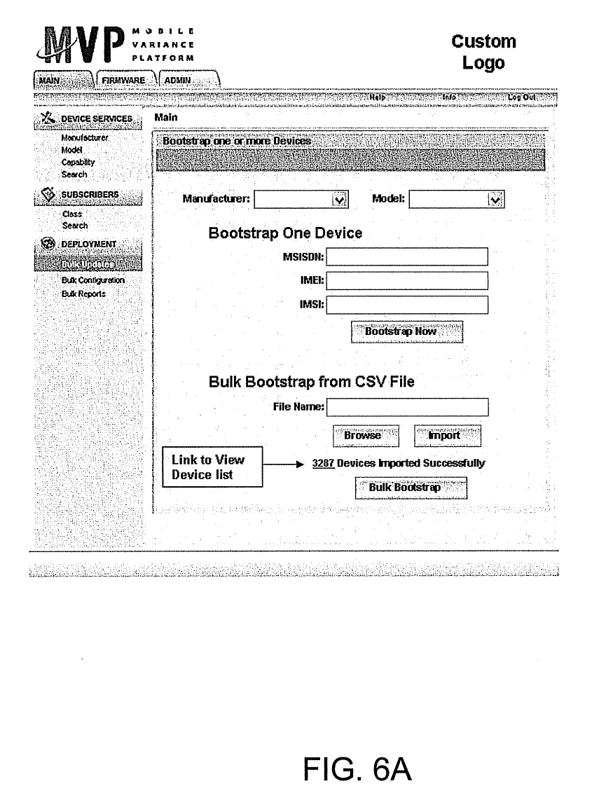

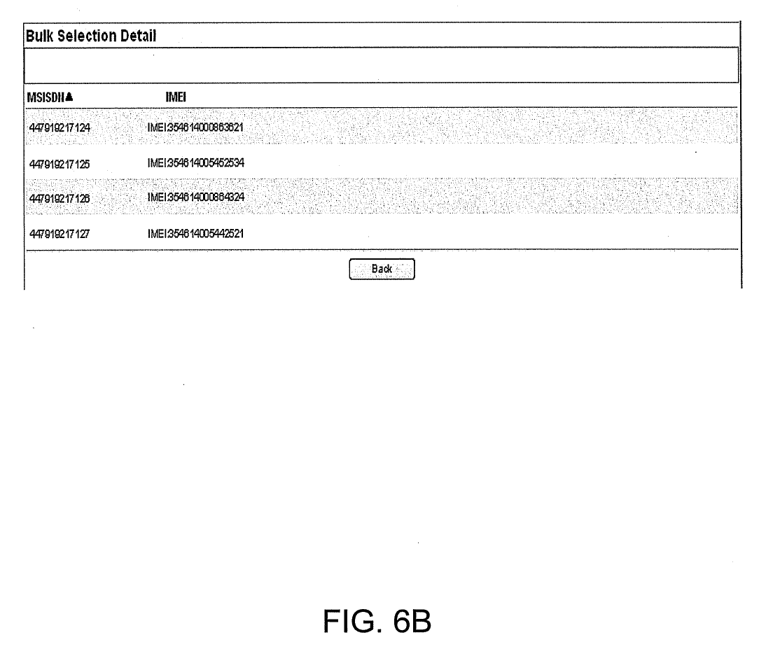

FIG. 6A is an exemplary user interface screen showing parameters and actions supporting both individual device bootstrap requests as well as bulk bootstrap operations, in accordance with a representative embodiment of the present invention.

A representative embodiment of the present invention may support the bootstrapping of mobile devices that have either not been pre-provisioned or have been previously provisioned for another Open Mobile Alliance (OMA) device management (DM) server.

Many carriers order handsets that have been specifically pre-provisioned for the carrier's network. However, it is often necessary to bootstrap one or more handsets to support smaller customer “trials” and other inevitable exceptions, such as the need to support mobile devices not purchased directly from the carrier. The exemplary user interface screen of FIG. 6A shows how a representative embodiment of the present invention can support both individual device bootstrap requests as well as bulk bootstrap operations.

In a representative embodiment of the present invention, bootstrap operations may be directed to a specific make and model, so that the device management server is able to determine what type of bootstrap message to send. The type and content of the bootstrap message may be configurable as device capability parameters. Plain profile bootstrap may be supported, with the understanding that the wireless application protocol (WAP)/CP “w7” profile may also be employed.

A representative embodiment of the present invention may provide a “one shot” bootstrap interface that bootstraps a single device on an exception basis, given the manufacturer, model, MSISDN, IMEI, and IMSI. Although shown in FIG. 6 as an optional interface to bulk bootstrap, this may also be implemented as a separate feature of the customer care UI.

In a representative embodiment of the present invention, bulk bootstrap suppot may be provided for a specified manufacturer and model through an external comma separated value (CSV) file imported from a bulk bootstrap UI. The contents of the CSV file may be MSISDN, IMEI, and IMSI, in that order. Exported and imported CSV files may contain MSISDN as the first field and IMEI (if known) in the second field. This convention is may allow a CSV file to be used for multiple purposes as discussed later in this Application.

Bootstrap operations may take 12-14 separate SMS messages to deliver a bootstrap message to a mobile device/handset. In a representative embodiment of the present invention, the number of SMS messages employed to bootstrap a specific device type may be maintained as a mobile device capability, so that the bulk service may adjust the overall SMS message rate for the higher SMSC load required for bootstrap operations.

A representative embodiment of the present invention may maintain knowledge of whether or not a specific device type is expected to start an OMA DM session as the result of a successful bootstrap operation. For devices that do start an OMA DM session, the effect of a successful bootstrap may produce the same results as if a query operation was issued (i.e., a device management server has now recorded the MMV information in its database). Should a mobile device type be unable to generate an OMA DM session, the carrier may use the same CSV file as input to a subsequent bulk query operation.

FIG. 6B is an exemplary user interface bulk selection detail screen showing selected target details, in accordance with a representative embodiment of the present invention. A representative embodiment of the present invention may allow review but not selection of individual targets.

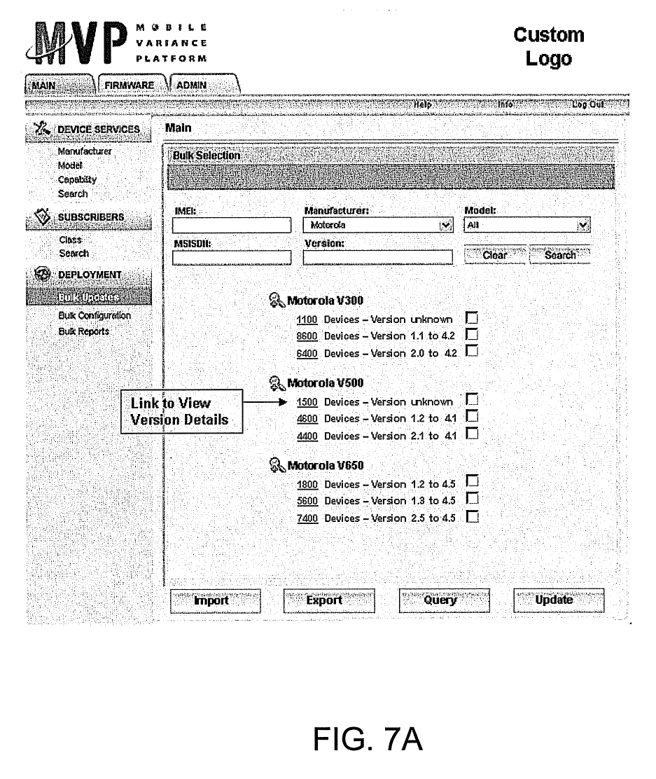

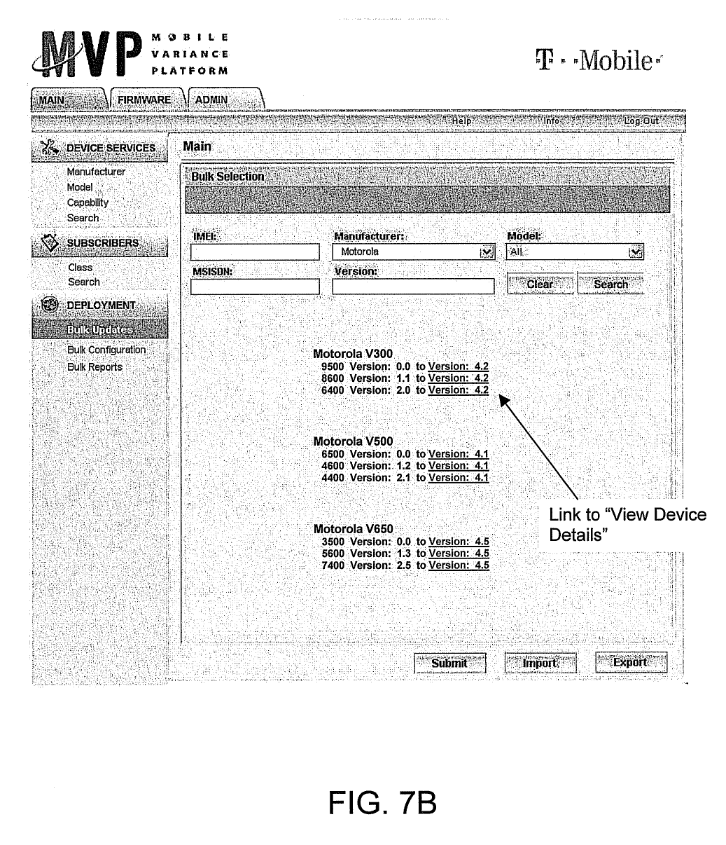

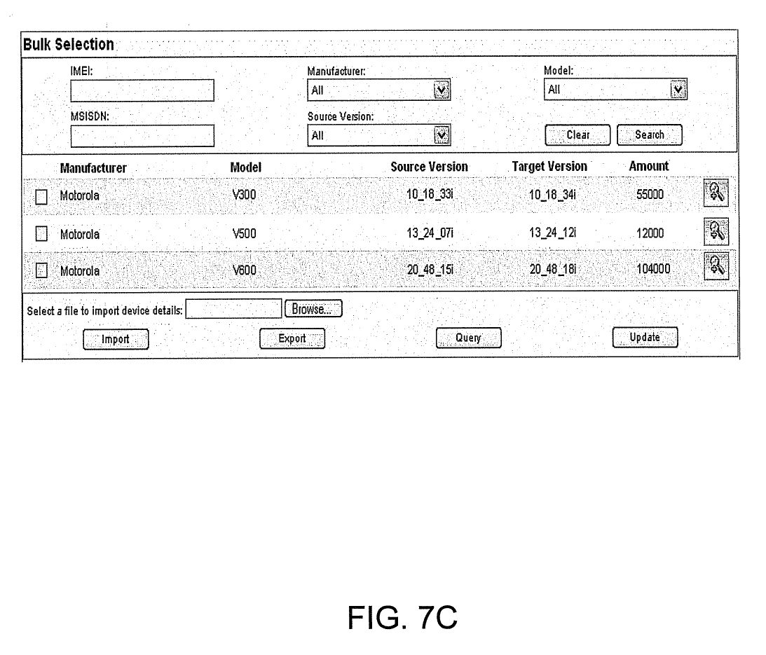

FIG. 7A is an exemplary user interface bulk selection screen used in selecting devices for bulk queries and updates that supports the creation, exporting and importing of collections of mobile devices to be updated, in accordance with a representative embodiment of the present invention. FIG. 7B is another exemplary user interface bulk selection screen that may be used in selecting devices for bulk queries and updates that supports the creation, exporting and importing of collections of mobile devices to be updated, in accordance with a representative embodiment of the present invention. A representative embodiment of the present invention may support the selection, export, and import of a list of mobile devices to be updated in bulk. A representative embodiment of the present invention may include a selection filter that enables targeting of specific devices or subscriber subsets. A selection summary may provide all selected instances with source, targets, and device type. In addition, a representative embodiment of the present invention may support the “Import” of lists from external sources. In some representative embodiments of the present invention, an Import capability may not provide detail information (i.e., make, model, firmware version). A user interface screen such as those shown in FIGS. 7A and 7B allow the bulk campaign administrator 1) to create a collection of devices directly from the device management server, 2) to export the collection to a CSV file for possible reuse or external processing, and 3) to import a previously saved or externally prepared list of mobile devices. This screen of a representative embodiment of the present invention allows a campaign administrator to select a set of mobile devices based on multiple criteria, including partial matches (e.g., IMEI TAC value, MSISDN country code, etc.).

Once a search is complete, a summary of the mobile devices selected and the proposed version upgrades may be presented. Clicking on the version detail links may reveal a list of the actual mobile devices and MSISDNs selected by the search criteria. The list of mobile devices may be exported to a CSV file for later use or external processing. Importing a saved device list may re-populate the above screen from previously saved results.

In a representative embodiment of the present invention, a device management server may be pre-provisioned with a list of IMEI/MSISDN pairs for the mobile devices to be supported. However, when the IMEI associated with an MSISDN is unknown, the MSISDN may be used to find the mobile device on the network. Once the mobile device is contacted, a representative embodiment of the present invention may record both the IMEI and the firmware version with the MSISDN, allowing more precise queries to be issued in subsequent operations.

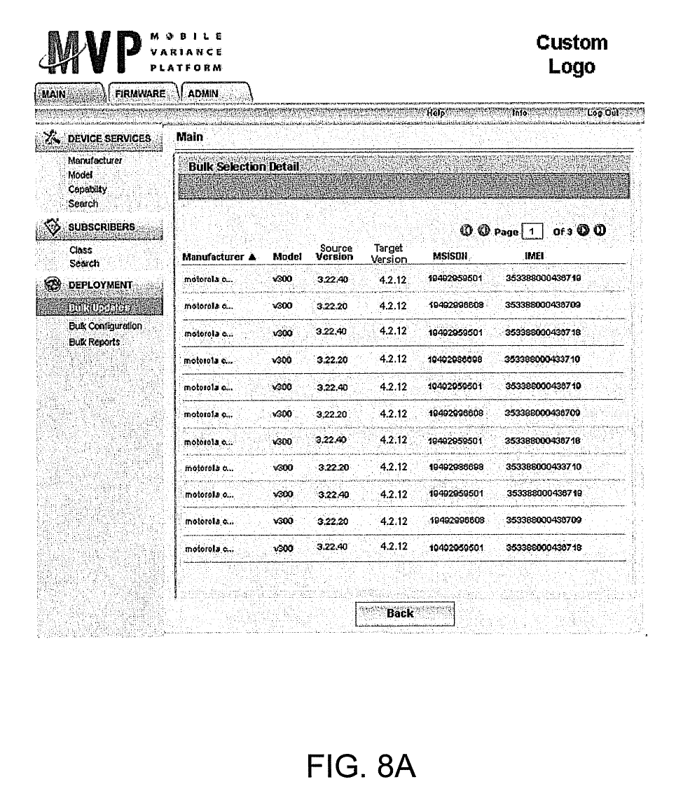

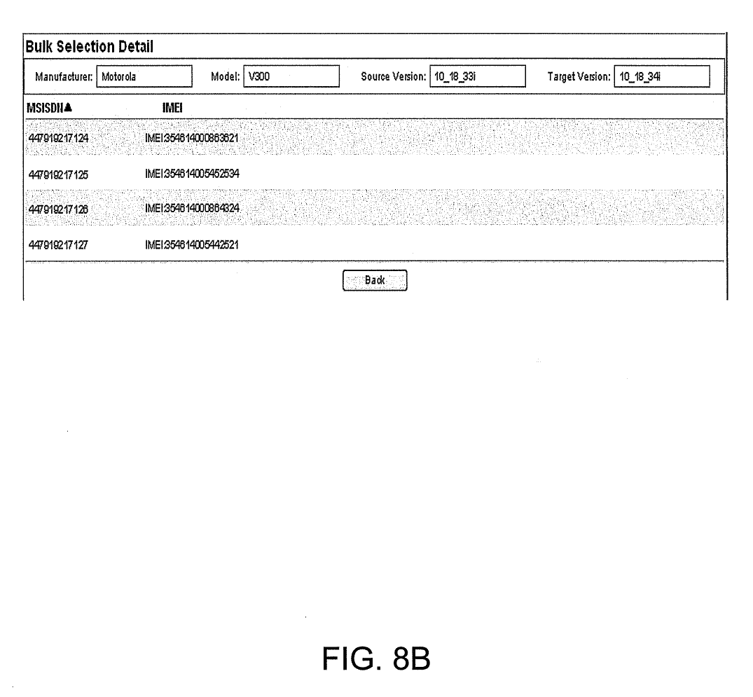

To the extent that a representative embodiment of the present invention has previously communicated with the mobile devices in question, version information will be up-to-date (i.e., as long as no out-of-band updates have been performed). When the mobile device version is unknown, the version may be shown as “unknown”. In any case, the true firmware version of the mobile device may be discovered during the FOTA discovery process, at which time the device management server may capture the correct version information, even if no update is needed. Note that the screen of FIG. 7 attempts to identify the mobile devices to be updated, down to the specific firmware version. For devices where the version is not yet known, a simple count may be displayed. In a representative embodiment of the present invention, clicking on a view icon or one of the version specific links of FIGS. 7A and 7B may bring up a mobile device detail screen such as that shown in FIGS. 8A and 8B.

FIG. 8A is an exemplary user interface bulk selection detail screen providing detailed device information for the device categories shown in FIGS. 7A, 7B, 7C supporting the creation, exporting and importing of collections of devices to be updated, in accordance with a representative embodiment of the present invention. FIG. 8B is another exemplary user interface bulk selection detail screen providing detailed device information for the device categories shown in FIGS. 7A, 7B, 7C supporting the creation, exporting and importing of collections of devices to be updated, in accordance with a representative embodiment of the present invention.

In a representative embodiment of the present invention, when the initial screen for selecting the devices for a bulk operation is displayed, as shown in FIGS. 7A, 7B, 7C, the list of devices may be empty until the user selects a set of devices either by using search capabilities detailed below, or by importing a CSV file specifying the devices to be used. As mentioned above, CSV files used to list mobile devices may contain the MSISDN as the first field, and the corresponding IMEI (i.e., when known) in the second field. In cases where the IMEI is unknown, the IMEI field may be either missing or empty.

User interface screens such as, for example, those shown in FIGS. 8A and 8B may support viewing detailed MSISDN and IMEI information for a specific make and model. A representative embodiment of the present invention may allow review, but may not allow selection of individual targets. In some representative embodiments of the present invention, detailed information may not be available when using Import functionality.

In a representative embodiment of the present invention, a user who chooses to use the search capability may specify any combination of IMEI, MSISDN, Manufacturer, Model, and version to form a Boolean AND expression. Partial values for IMEI (e.g., the first six digits that contain the TAC field) and MSISDN (e.g., country and/or area code) may be specified. If the search is successful, and the IMEIs are known, a summary of what mobile devices may be updated and to which firmware versions may be displayed, as shown in the examples of FIGS. 8A and 8B. In this view, the user may browse the results for specific proposed version updates by clicking the link associated with the target version. If the device management server only has MSISDNs in its database, the search capabilities may be restricted to using the MSISDN alone, resulting in a simple summary of the number of MSISDNs that matched the search expression.

In a representative embodiment of the present invention, once a collection of mobile devices is established, the list of mobile devices may be exported, in a CSV file with the following fields:
MSISDN
IMEI or “unknown”
Manufacturer or “unknown”
Model or “unknown”
Assumed source version or “unknown”
Assumed target version or “unknown”

The term “assumed” is used because version information may not be known until the device responds to the update notification and reveals its current MMV information. Nonetheless, it may be expected the a device management server in a representative embodiment of the present invention will have the correct version information almost all of the time, since out-of-band updates should be very rare.

In normal long term use, a representative embodiment of the present invention may be expected to have up-to-date mobile device data (IMEI, and MMV) in its database. When this is the case, clicking on the target version link may bring up the device detail display for that subset of the mobile device collection, as shown in the example of FIGS. 8A and 8B. Using the exemplary user interface screens of FIGS. 8A and 8B, the user may browse the list of mobile devices to make sure that the search expression found the mobile devices that were intended, and omitted those that were not intended.

In a representative embodiment of the present invention, some columns may be eliminated when the context of the detailed display (FIGS. 8A and 8B) is already known. However, if screens such as those shown in FIGS. 8A and 8B are used in other contexts, a representative embodiment of the present invention may use a common format across all such displays, when all of the information can be shown in a standard browser window without scrolling.

In a representative embodiment of the present invention, the IMEI of the mobile device that responds to the update notification may or may not match the IMEI specified. This ambiguity may be controlled by the user during submission.

The mobile device detail navigation controls of a representative embodiment of the present invention provide the means for moving forward, backward, to the beginning, the end, or to a specific page of a mobile device list. This allows the user to check first, last, and a few intermediate pages to be assured that the search produced the expected results.

This detailed display of selected devices and projected version updates may be employed when 1) the search is done directly from the device management server database, and 2) the device management server database has the necessary IMEI data. When a mobile device collection is built from an external CSV file, or when no IMEI data is available to the device management server, the mobile device detail display may be omitted.

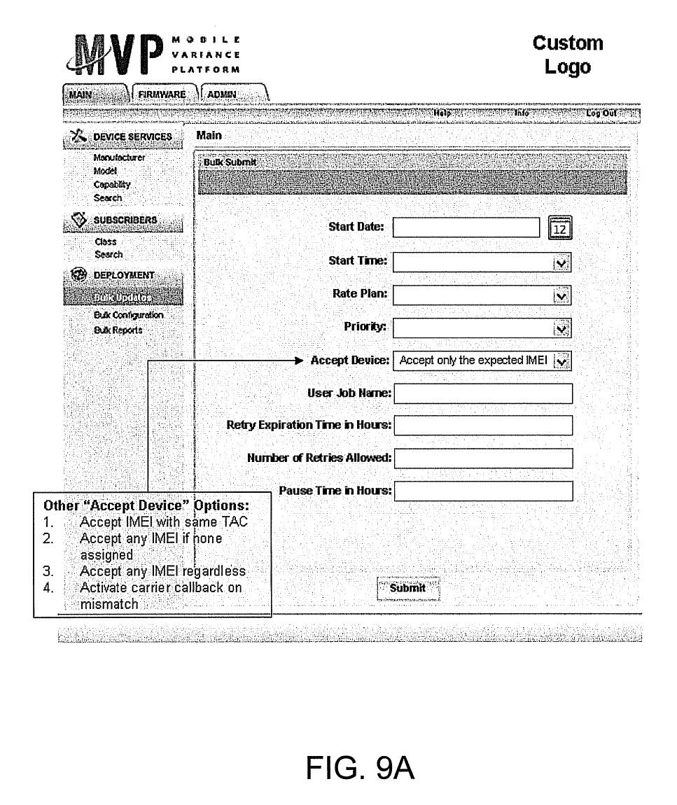

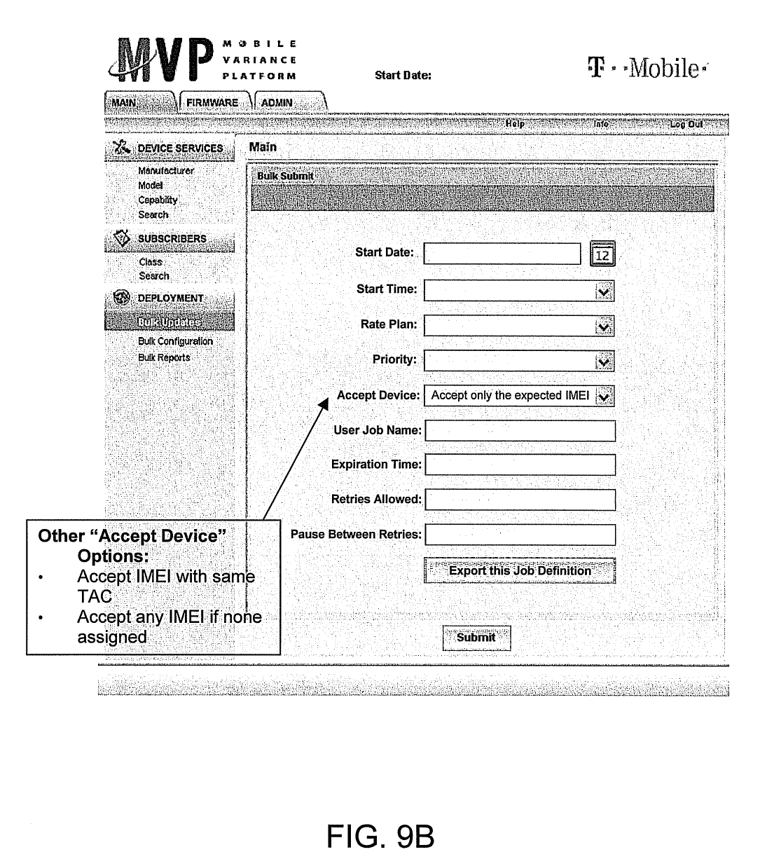

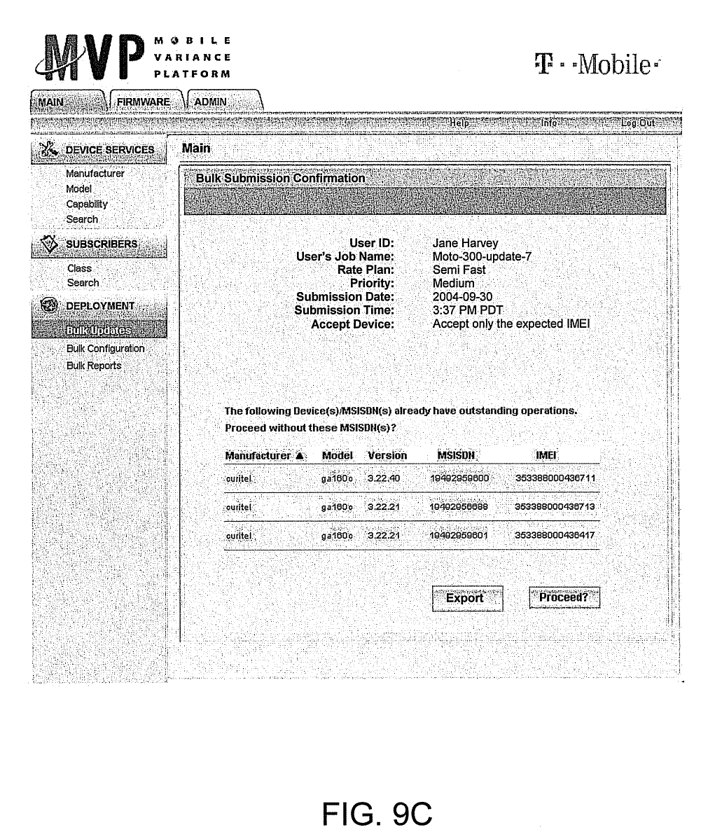

FIG. 9A is an exemplary user interface screen supporting bulk job deployment, in accordance with a representative embodiment of the present invention. A representative embodiment of the present invention may support the submission of a bulk job to be started at a specific time with a specific activation rate, priority, and retry parameters.

In a representative embodiment of the present invention, rate plans may control the rate, in “tasks activated per second”, at which tasks from a bulk job may enter the active state. Specific details and requirements on rate plans are discussed below. In the user interface screen shown in FIG. 9A, the bulk administrator may choose a previously defined rate plan from the drop down list, using its carrier specified name. Each job may be assigned a unique ID, but may also be given a user-specified name to allow easier retrieval of status information concerning the status of the job.

The user interface screen shown in FIG. 9A results in the creation of a bulk job once the Submit button is clicked and the request accepted. At that point, the job may be assigned a unique job ID, and all the tasks created from this bulk job may be clearly identified as belonging to this job ID.

In a representative embodiment of the present invention, if an MSISDN selected in this job is also included in another active bulk job, the MSISDN may be excluded from the job being submitted automatically, leaving a message to this effect in the log information for this MSISDN. The first update may achieve exactly the same result as the subsequent update, so there is little to be gained by burdening the user with some form of conflict resolution.

In a representative embodiment of the present invention, the start date and time shall may specify when the job may be started. No tasks from this job may be started before this time. The actual start time may subject to system load, other pending jobs, priority, rate plan, and the global “refresh cycle time”. Thus, once the start time arrives, the job may be allowed to compete for resources, but may not be guaranteed to actually start at that time, subject to other bulk operation parameters and controls.

The user of a representative embodiment of the present invention may be offered a choice of rate plans in the form of a drop down list of predefined rate plans associated with the user's user group (e.g., region). All rate plans may be specific to a user group, such that the only rate plans available to a user are those specific to the user group. The chosen rate plan may govern how quickly tasks from this job can be placed into the active state.

In a representative embodiment of the present invention, the priority value may span from 1 (i.e., highest) to 10 (i.e., lowest). Priority may be treated as “absolute”, meaning that all higher priority work may be serviced before any lower priority work is serviced. In a representative embodiment of the present invention, rate plans offer the flexibility to control how fast a job progresses. Priority may be used in situations where a job or a set of jobs are to be service before all others, or are to be treated as a background activity when no other jobs are active. Priority may be treated as “absolute”, to avoid conflict with rate plans. Thus, when operating at a specific priority level, only the rate plans of the jobs within that priority level may be considered for activation. In a representative embodiment of the present invention, priority may be used to handle exceptions, but rate plans may be the primary vehicle for controlling bulk job workflow.

In another representative embodiment of the present invention, priority may be replaced by an “emergency” flag to handle the one case that rate plans may not optimally handle, namely the forcing of a bulk job to the “head of the queue” at the complete exclusion of all non emergency jobs.

In a representative embodiment of the present invention, a bulk server may provide a drop down set of options to allow the user to control the handling of a different device responding to the notification of an MSISDN than the IMEI expected. The following options may be supported:
1. Accept only the specific IMEI (may be the default)
2. Accept any IMEI with the same TAC. The TAC is the first six digits of the IMEI and specifies the device type.
3. Accept any IMEI, if no IMEI yet assigned
4. Accept any IMEI, even if a different already assigned
5. Activate the carrier callback on IMEI mismatch. Any use of the carrier callback feature may involve carrier specific policies.

If the IMEI test fails, the task may be reported as failed, using a result code in a “vendor specified” range (i.e., “500-599”), as specified in the Open Mobile Alliance (OMA) Device Management (DM) Firmware Over-The-Air (FOTA) standard.

In a representative embodiment of the present invention, each job may be identified by a user specified job name, as illustrated in the example of FIG. 9. The job name may only be unique for the current user. This may be accomplished by pre-pending the user ID to the user's job name. This may permit users to give their jobs descriptive names like “update-V300s”, so that the user can quickly identify any reporting data associated with that job.

The retry expiration time in a representative embodiment of the present invention may specify the number of hours to allow a task from this job to remain active and not completed, before the task is deemed to have failed. This may range for example, between 48 to 72 hours. Note that this value may also be used to set the expiration time for the initial SMS notification message. If an update is not achieved before the retry expiration time is reached, the notification message may expire, and the device management server may assume that the update attempt has failed.

Once the mobile device calls in, a representative embodiment of the present invention may grant additional time for the update to complete, as long as the update session appears to be progressing. User input may not be required beyond the initial retry expiration time. A representative embodiment of the present invention may permit some degree of tuning of this value.

The “retries allowed” setting of FIG. 9A may establish the number of retries attempted as the result of an expiration time out or other non-fatal error. An example retry count may be in the range of 2 to 4 (i.e., 3 to 5 total attempts) before a task is permanently marked as failed.

The “pause between retries” entry in FIG. 9A may be used to specify the time in hours before a failed update attempt may be retried. Values of this variable may be in the range of 2 to 5 hours.

A representative embodiment of the present invention may support the definition of various “rate plans” that control task activation rate for a specific bulk job. A rate plan may be used to control the rate at which bulk update tasks are allowed to enter the active state for each hour of the day, with specific hourly rates specified for days of the week, weekends, and special days. Rates may be specified in terms of tasks activated per second so that the impact on the targeted SMSC can be clearly understood. However, actual enforcement may be performed less often than once per second (e.g., 3 per second equates to 180 per minute).

A representative embodiment of the present invention may schedule bulk jobs by start date and time. The start time may employ a 24 hour clock having a range of between 00:00 to 23:00 hours. Such a representative embodiment may support selection of a SMSC rate plan to manage SMSC rate throttling on a per hour and/or per day basis. A user may be permitted to set priority for critical vs. non-critical updates, and set retry parameters for non-successful tasks. A retry expiration time may be specified as the number of hours allowed for a task to remain active. In some representative embodiments of the present invention, the parameters specified by a user may refer to a particular task, and not to a job.

FIG. 9B is another exemplary user interface screen supporting bulk job deployment, in accordance with a representative embodiment of the present invention. A representative embodiment of the present invention may support the submission of a bulk job to be started at a specific time with a specific activation rate, priority, and retry parameters. This user interface screen is substantially the same as the user interface screen of FIG. 9A, with the exception of the addition of a “Export” button, that permits the export of job information to another application or tool.

FIG. 9C is an exemplary user interface screen supporting confirmation of bulk job submission, in accordance with a representative embodiment of the present invention.

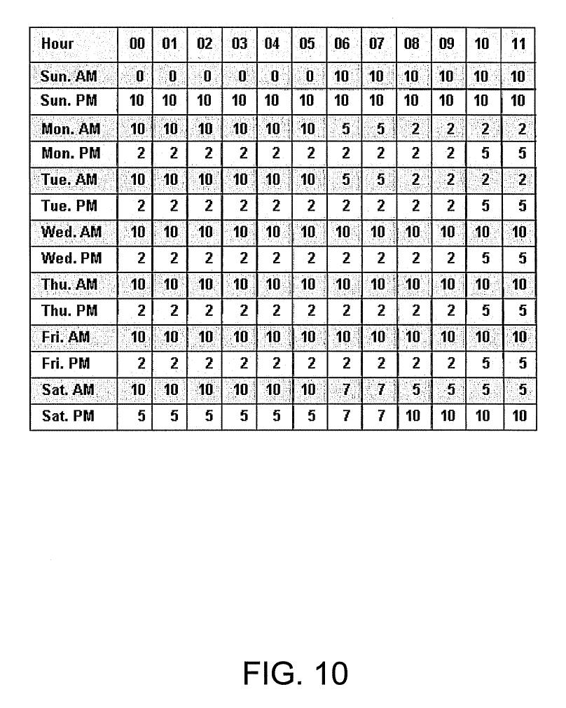

FIG. 10 is an illustration of an exemplary rate plan table specifying the activation rate for a rate lane for every hour of a week, in accordance with a representative embodiment of the present invention. Rate plans in a representative embodiment of the present invention may be date/time independent, and several rate plans may be created to accommodate different levels of urgency, different time zones, regional considerations (e.g., SMSC capacities), and the overall rate at which a specific campaign requires to meet its goals. Rate plans are much more flexible than priority, as they allow high rate work (say 10 activations per second) to be intermingled with low rate work (e.g., 2 activations per second), allowing each to make progress in accordance with their specified rates.

In a representative embodiment of the present invention, each rate plan may be given a user-friendly name at the time of creation, to allow easy access to different rate plans. Rate plans may be associated with a set of exception dates, discussed in greater detail below.

The times in the table of FIG. 10 may be given in the rate plan creator's time zone by default, but may be created for any time zone. A representative embodiment of the present invention may store rate plans in Universal Coordinated Time (UTC), but may render times in the user's specified local time zone.

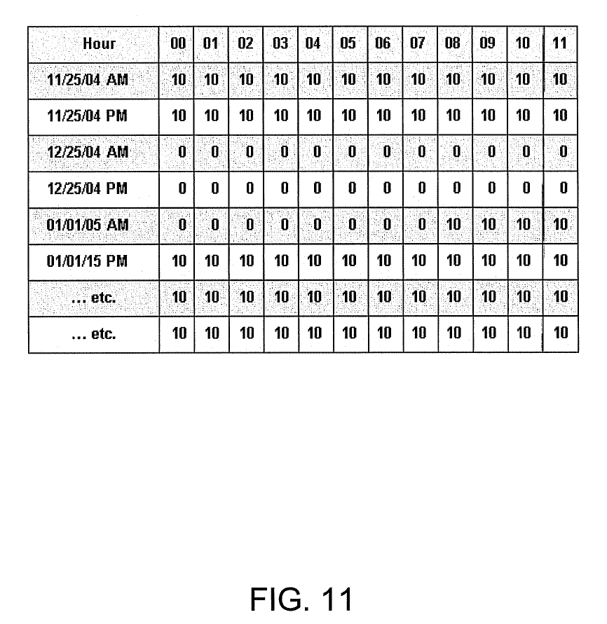

Special days and holidays may be handled as exceptions to the weekly rate plan shown in FIG. 10. Thus, every rate plan may have an associated “exception list” which is checked before using the rate from the base rate plan. FIG. 11 is an illustration of an exemplary exception list that may be associated with the rate plan table of FIG. 10, in accordance with a representative embodiment of the present invention.

In a representative embodiment of the present invention, each exception table may also be given a unique name, to allow it to be selected into a rate plan by its name. Each rate plan may refer to only one set of exception dates. Note that exception dates may be updated at least yearly, while the base rate plans may be completely date independent.

A representative embodiment of the present invention may provide an easy to use web UI for creating named rate tables and named special day (i.e., “exception”) tables. Since there may be a great deal of repetitive data in these tables, the use of “data entry assists” may be helpful. One such assist may support a mode where adding a number to a blank cell causes all blank cells to the right to be filled automatically with identical values. Another aid might be to add a control that duplicates the contents of an entire day into the value of the next unfilled day.

It should be noted that the rate and exception tables illustrated in FIGS. 10 and 11 show a rate plan and an exception list as they might look upon completion. The look and feel, and the controls on the UI used to produce this information are not shown. Any suitable user interface may be employed without departing from the scope of the present invention.

In a representative embodiment of the present invention, each rate plan may be associated with a named special day plan (i.e., “exception list”). Special day plans may be shared across multiple rate plans and as such may be maintained separately.

A rate plan may be bound to a specific user group (e.g., as might be associated with a country or region). This may serve to bind the rate plan for use with any specific SMSC and SMSC message rate associated with that group or region.

The times in the rate plan may be displayed in the user's time zone or a specific time zone set by the user. Internally, all times may be maintained in UTC (formally known as Greenwich Mean Time (GMT)). This allows the device management server to use UTC time for all time calculations, regardless of what time zone is used to establish the rate plan.

Rate plans are set in terms of activations per second to make it easier for carriers to understand activation rates in the same terms as they view SMSC message rates. Whenever the MVP needs to activate additional tasks, the activation rates shall govern how many tasks for which jobs shall be activated.

By way of example, consider three jobs, A, B, and C, each with a large numbers of tasks waiting to be activated. For the current hour, the job rate tables may specify the following activation rates:
Job A—3 activations per second
Job B—5 activations per second
Job C—8 activations per second

A representative embodiment of the present invention may apportion the work by activating three tasks for job A, five from job B, eight from job C, and so on until the maximum number of active tasks is reached. The tasks may also be activated in larger groups, as long as the activation ratio established by the respective rate plans is maintained for each activation cycle.

In a representative embodiment of the present invention, if the aggregate activation rate across all jobs exceeds the overall rate specified for the SMSC to be used, the individual job rates may be “downsized” to fit the available SMSC bulk job rate in proportion to the rates specified for each job. This aspect of a representative embodiment of the present invention prevents an ill-conceived set of rate plans from exceeding the specified maximum SMSC capacity for bulk jobs.

In a representative embodiment of the present invention, the aggregate rate of an active set of bulk jobs may not exceed the total rate across these jobs. For example, in the above 3-5-8 example, the listed jobs, collectively, may not exceed the aggregated rate of 16 activations per second, even if there “appears” to be unused SMSC capacity. Such unused capacity needs to remain available for subscriber revenue producing work. Rate plans may be designed to “back off” during peak periods as shown in the rate table examples of FIGS. 10 and 11.

A representative embodiment of the present invention may support the reporting of status information on current and previously completed bulk jobs, with the ability to view specific job and task status, and the canceling of a specific job or task.

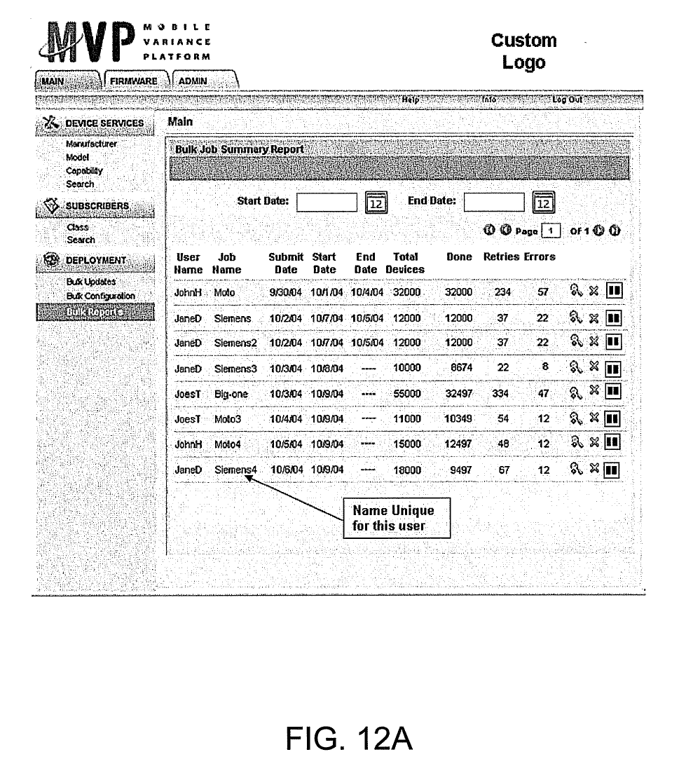

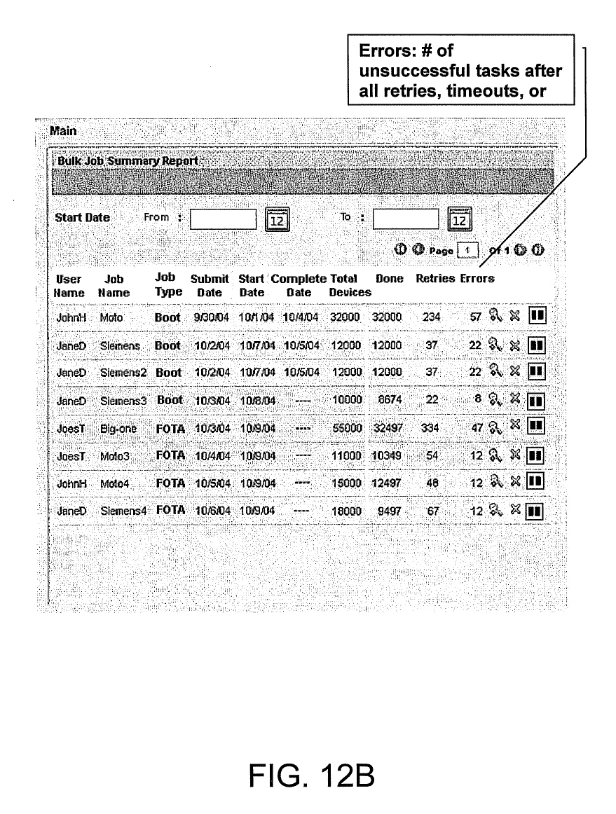

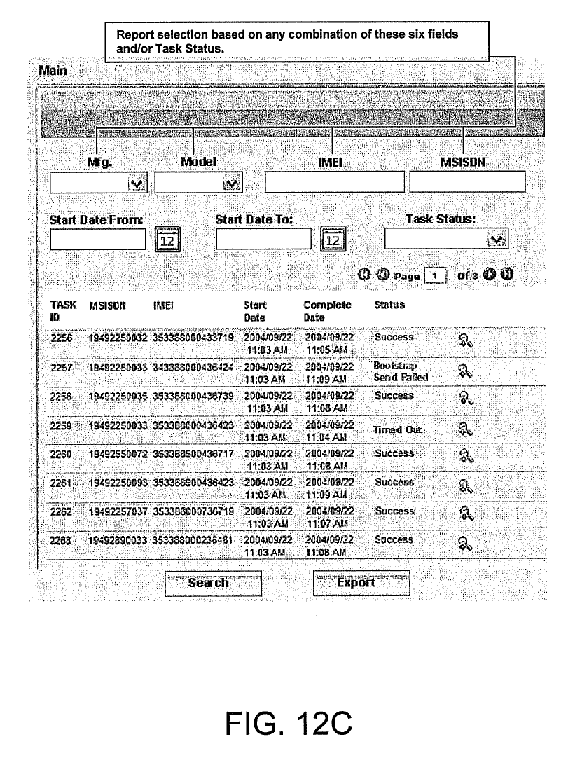

FIGS. 12A and 12B illustrate two views of an exemplary user interface bulk job summary report screen showing a summary report of current bulk jobs, in accordance with a representative embodiment of the present invention. In the illustrated example, clicking on the “X” in the second column from the right brings up a job cancel options screen for user confirmation, and provides the user with the option of saving a list of mobile devices not yet activated to a CSV file for possible job restart at a later time. Clicking on the pause button (i.e., the rightmost column) causes suspension of the activation of any new tasks for the affected job until the job is “un-paused”. In a representative embodiment of the present invention, user interface screens such as those illustrated in FIGS. 12A and 12B may provide a summary of progress of each active bulk job. Such screens may include, for example, an indication of total mobile devices affected, total number of completed devices, total number of retries, and total number of failures. The user interface may include the ability to pause and/or cancel active bulk jobs. In a representative embodiment of the present invention, the list of mobile devices may be filtered by date range. The screens may also include links to detailed views of each job.

A representative embodiment of the present invention may provide a summary report for all bulk jobs started within a specified date range. This report may allow the user to navigate to the first, last, next, previous, or a specific page of the report. The specific data shown may include the following:
User ID or the user submitting this job
User defined job name
Internal Job ID (not shown in the example)
Job submission date/time
Job start date/time
Job end date/time (when available)
Total devices in the job
Number of devices updated
Total number of retries
Total number of non-recoverable errors

Clicking on a column heading may sort the report based upon the contents of that column.

In a representative embodiment of the present invention, if a particular graphical element is clicked within the job summary report, the user may be prompted with the following options concerning the associated job:
Abort this job
Abort this job, and log all unfinished tasks to a CSV file
Cancel (do nothing)

If the user chooses to abort the job, all tasks that have not yet been activated may be aborted. If a CSV file is requested, a “Save As” dialog box may appear and the MSISDN and IMEI (if available) associated with each cancelled task may be written to the specified CSV file.

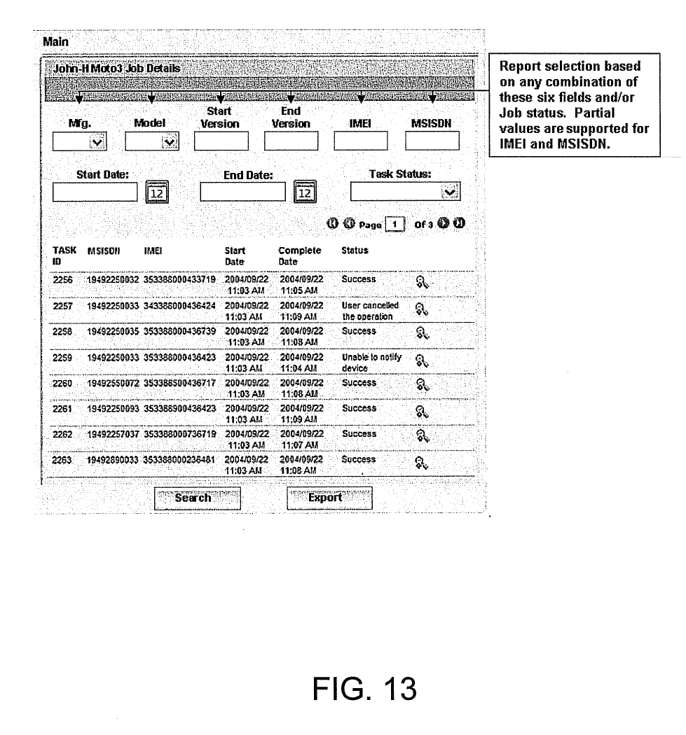

In a representative embodiment of the present invention, if a job “pause” button is clicked, no further tasks may be activated from this job until the job is either cancelled or “un-paused”. Note that the pause icon may change to an “un-pause” icon (something like [symbol] ) to indicate a paused job and provide a means to resume the job. In a representative embodiment of the present invention, clicking on the view icon may bring up a job detail screen, such that shown in FIG. 13.

FIG. 12C illustrates an exemplary user interface bulk job details screen showing the details of a single bulk job, in accordance with a representative embodiment of the present invention. In a representative embodiment of the present invention, a screen such as that shown in FIG. 12C may be used to provide details of single bulk job. Information presented may be filtered using several key parameters. A bulk job details screen in accordance with a representative embodiment of the present invention may list each device/subscriber within an active bulk job, and may include links to a detailed view of each task in the job. Such a screen may also provide an option to export list and status information for external analysis.

FIG. 13 is an exemplary user interface job detail screen showing job detail information including status for each device/task associated with a bulk job, in accordance with a representative embodiment of the present invention. Note that the resulting device status may be reduced to show specific details for any combination of manufacturer, model, starting version, ending version, IMEI, MSISDN, and job status. Partial values may be supported for IMEI (e.g., TAC field) and MSISDN (e.g., country and/or area code). The resulting status reports can also be exported to a CSV file for offline processing. In a representative embodiment of the present invention, a job detail screen such as FIG. 13 may provide details of single bulk job. The information displayed may be filtered by several key parameters, and may list each device/subscriber within an active bulk job. If a magnifying glass icon is clicked within the job summary report, the job detail report for the associated job may be displayed. A screen such as job detail screen of FIG. 13 may include links to a detailed view of each task, and may provides an option to export list and status information for external analysis.

The job detail report may display the summary status of each task within the job, including:
Internal Task ID
MSISDN
IMEI (if available)
Manufacturer (not shown in example)
Model (not shown in example)
Source version (not shown in example)
Target version (not shown in example)
Task activation date/time
Task completion date/time (when available)
Current or final task status

The job detail report may allow the user to navigate to the first, last, next, previous, or a specific page of the report. Also, the user may be able to display subset report data based on any of the following search report criteria, forming an AND expression:
MSISDN
Manufacturer (drop down)
Model (drop down)
Source version
Target version
Start date
End date
Task status (drop down)

Clicking on a column heading may sort the job detail report based upon the contents of that column. The user may also be able export the data currently displayed to a CSV file.

Clicking on an “Export” button may copy the currently display data to a CSV file for possible off line processing.

The job detail report may also provide a “Cancel Job” button, which may behave exactly the same as described above.

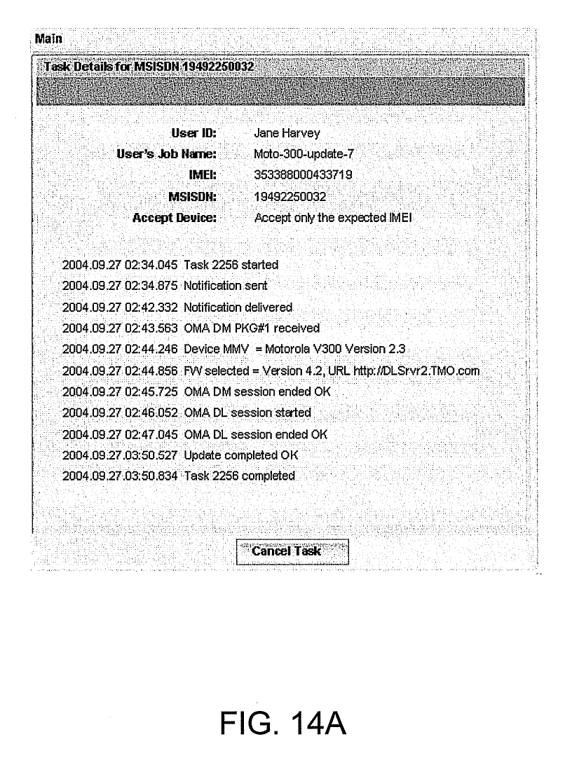

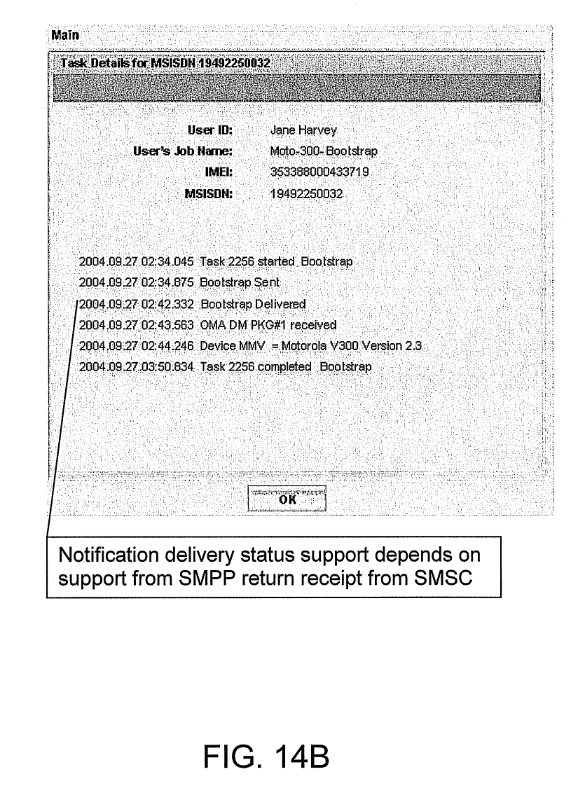

Clicking on the magnifying glass for a specific device may bring up the device detail screen shown in FIG. 14.

FIG. 14A is an exemplary user interface task details screen showing device detail information for a specific device shown on the job detail screen of FIG. 13, in accordance with a representative embodiment of the present invention.

If a magnifying glass icon is clicked within the job detail report, the task detail report may be displayed as shown in the example of FIG. 14. The task detail report may display job, device, and task detail followed by a list of all log entries that report on the ongoing state of the task, including:
Task activated
Notification sent
SMSC status
Notification delivered (very important to at least one carrier)
PKG# 1 received
Authentication status
Discovery status and MMV data
Firmware selected (or none available)
Discovery session end status
Download session started
Download session ended status
Final status reported by device
Final session end status
Task completion status

A representative embodiment of the present invention may provide details of a single DM operation task, and may provide detailed visibility into all events for a single device with date/time stamps. Such detailed information may be useful for debugging failed tasks.

In a representative embodiment of the present invention, if there is a mobile device that is already in an active job or is already scheduled, the device management system may automatically exclude the mobile device from a job. In some representative embodiments of the present invention, a device management server may not give a warning message about conflicts, and Import functionality may not provide MMV information before task execution. This may be due to system performance constraints on a particular platform, and may not affect other support platforms. In some representative embodiments of the present invention, bulk query and bulk update may be identical in both workflow and in user interface screens. In other representative embodiments of the present invention, bulk query and bulk update workflow and in user interface screens may be different. The job type entry on list views may indicate whether bulk update or bulk query is being performed.

FIG. 14B is another exemplary user interface task details screen showing device detail information for a specific mobile device, in accordance with a representative embodiment of the present invention. A task details screen in accordance with a representative embodiment of the present invention may provides details of a single DM operation task, and may provide detailed visibility into all events a for single mobile device, including date/time stamps. Such detailed information may be useful for debugging failed tasks.

A representative embodiment of the present invention may support bulk job management, and may include the following exemplary features:
job activation/notification rates at the job level
Separately maintained, time independent “rate plans”
Global controls to prevent network or system overload
Controls maximum load on SMSC
Controls overall system load at the task level
Web UI for job selection, submission, and reporting

A representative embodiment of the present invention may also support job recovery management, and may include the following features:
Automatic job restarts after “recoverable” failures
Restart parameters set at the bulk job level
Downloads restarted at last successful “byte range”

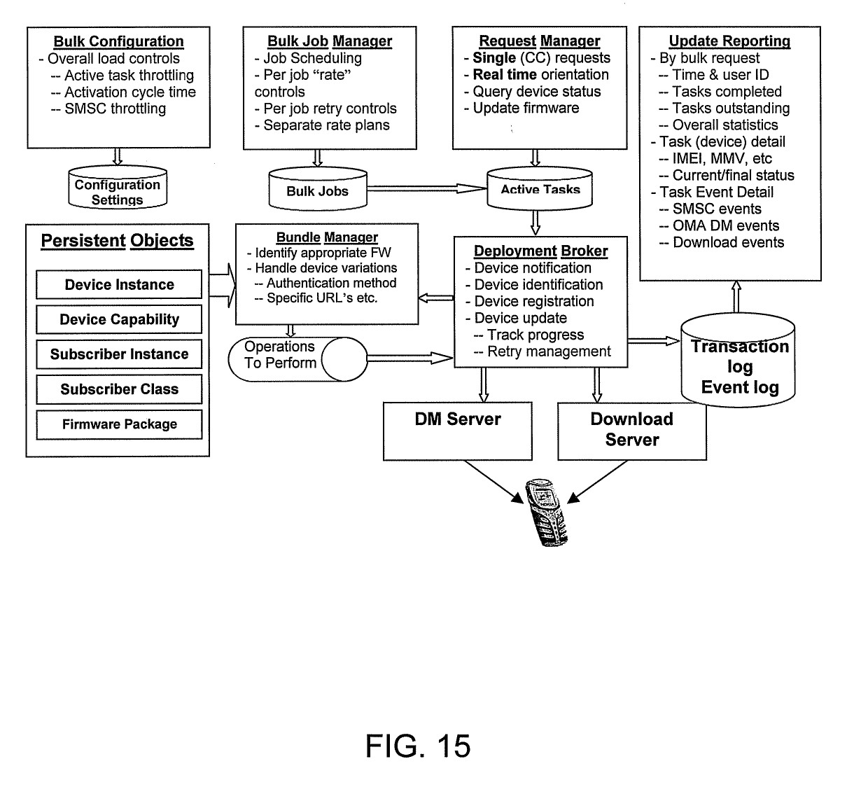

FIG. 15 illustrates an exemplary architecture of a device management system in accordance with a representative embodiment of the present invention.

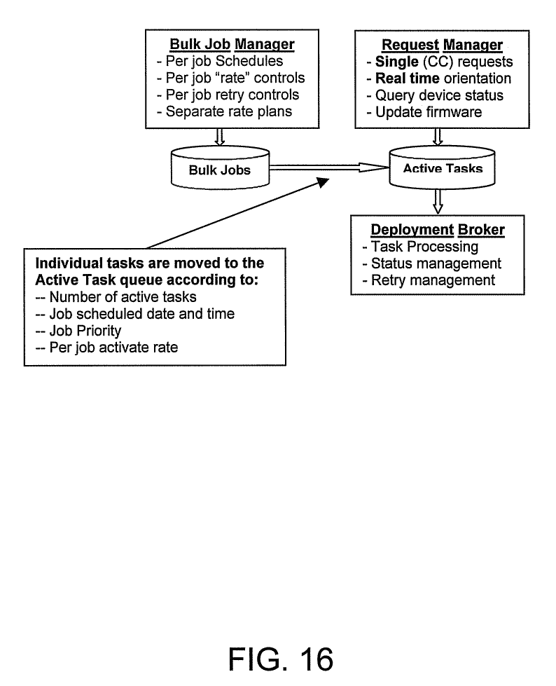

FIG. 16 is a block diagram illustrating an exemplary set of system entities that may be involved in the activation and management of tasks of a job, in accordance with a representative embodiment of the present invention.

In a representative embodiment of the present invention, a “task” may represent an update to a single mobile device. Each task may be queued and processed separately, and tasks may be activated and tracked by MSISDN and an internal “Task ID”. A “Job” may contain one or more tasks, and a job and its tasks may be tracked by a Job ID, user ID, and job name. A bulk job may be a set of tasks identified by a list of MSISDN's. Each task may be identified by its parent job ID.

In a representative embodiment of the present invention, tasks in a bulk job may progress by time and rate. Tasks may be held in a “bulk job queue” until activated, and tasks may be moved to an “active task queue” to activate processing. Activation may be controlled by job specific dates/times and activation rates. The size of the active queue may limit the number of active tasks, and the order of tasks in the active queue may represent priority order and “rate”. No size limit may be placed on inactive tasks.

In a representative embodiment of the present invention, management of the active queue may involve management of a number of system parameters and functions. For example, in a representative embodiment of the present invention, the number of active tasks may be limited to control overall system load. Only active tasks may be allowed to compete for system and network resources. Queue size, schedule, priority, and rate may control task activation. There may be no limit on the number of jobs or number of inactive tasks in the system.

In a representative embodiment of the present invention, a number of different task activation criteria may be employed in determining when a task is activated. For example, active queue size (i.e., the number of tasks that can be active at one time), job priority (e.g., tasks of a higher priority job may be activated before those of lower priority), job specified date and time schedules (e.g., one or more date/time sets), and the activation rate (i.e., the number of activations per second). A limit may also be placed on overall SMS notification rate.

A representative embodiment of the present invention may support task recovery. Notification may be sent with the job specific expiration time. Once an OMA DM job is established, the time to live may be the same as the expiration time. If a delivery receipt is received but no session results, it may be assumed that a “cancel” was performed. If no session is created within the expiration time, a representative embodiment of the present invention may retry up to a retry count. If session fails, a representative embodiment of the present invention may retry the task, unless the retry count has been exceeded.

The following discussion provides additional details about the principal functions and objects employed in a representative embodiment of the present invention.

A representative embodiment of the present invention may comprise client and Server components that work together to initialize and update mobile devices over-the-air. This concept has practical application for carriers that need advanced over-the-air (OTA) device management (DM) capability, including, for example,
Automatic device detection and regionalization
Firmware Upgrade
Application parameters provisioning
Application and data download
GSM Automatic mobile device detection upon network “attach”

A number of terms may be used to describe activities, elements and functions of a representative embodiment of the present invention. The following definitions may aid in the understanding of the subsequent discussion.

As used herein, the term “bundle” may be defined as a collection of device initialization, upgrade, and application provisioning “steps” to be executed in sequence across the protocols needed to achieve the required device updates. Such steps may include firmware upgrade, “Flex” data update, data application settings, and any number of data and application packages to be downloaded to the device (wallpaper, screen savers, Java Applications, etc.).

As used herein, the term “bundle manager” may be defined as a device management system component that transforms a set of subscriber attributes and data values into a bundle of operation steps to be performed on a specific device known to have a specific set of device capabilities.

As used herein, the term “device detection” may be defined as the process by which MVP detects the presence of a new device and subscriber combination on a carrier's network. Two methods of detection are covered here, 1) one in which a device management client detects a new subscriber identity module (SIM) card in the mobile device, and 2) one in which a proactive SIM applet notifies a device management server of its detection of a new device.

As used herein, the term “device identification” may be defined as the process by which a device management system identifies the make, model, and version information of a device in order to understand what firmware resides on the device and the resulting device capabilities of the device. (Note that device capabilities may depend on the firmware installed, not just the device make and model.)

As used herein, the term “device instance” may represent a single device identified on the mobile network by its “device ID” (e.g., IMEI or ESN). Under normal circumstances, each device instance is associated with a specific subscriber MSISDN or MIN, except for “borrowed” or “stolen” devices discovered on a GSM mobile network.

As used herein, the term “device capability” may describe the capabilities of a specific class of device as identified by its make, model, and firmware version (MMV). Note that capabilities such as “supports Java MIDP 2.0”, or “supports Email” may be dependent on firmware version.

As used herein, the term “firmware version” may describe a single or multiple values. In this document, the term “firmware version” is frequently referred to as if it were a single value. More commonly, it is necessary to consider other values as well, such as “software version” and “flex version”.

As used herein, the term “job” may be defined as a collection of “job steps” to be performed on one or more mobile devices, which has been scheduled as a single request. Once the capabilities of a device are known, the broker in a device management system may create a “bundle” of job steps to execute the job in a manner appropriate to the current device capabilities.

As used herein, the term “job ID” may be used to represent a unique ID that represents a job in process, to allow results and status to be correlated to the initial broker request.

As used herein, the term “OMA DM server” may be used to represent a device management system component capable of retrieving, setting, and modifying OMA DM management tree objects and supporting the emerging OMA DM firmware upgrade standard.

As used herein, the term “OMA download server” may be used to represent as a device management server or system that implements V1.0 of the Open Mobile Alliance (OMA) Download protocol.

As used herein, the term “OMA client provisioning protocol” may be used to represent the protocol used to define various mobile device settings and application characteristics. In a representative embodiment of the present invention, an OMA Client Provisioning document is delivered to the mobile device using an OMA Download or OMA DM protocol.

As used herein, the term “management server” may be used to represent an abstract component, used by a broker component in a representative embodiment of the present invention for device identification as well as for the initiation and management of firmware upgrade and content download services. All device management client/server “management” operations may be handled by the management server. The role of “management server” is normally provided by an OMA DM server, using an OMA Device Management protocol, except in cases where OMA DM is not supported on a mobile device/handset.

As used herein, the abbreviation “MMV” refers to a combination of values that define a device Make, Model, and (firmware) Version. Note that firmware “version” may also be represented by a number of values as defined above.

As used herein, the term “DM server” may be used to represent a server component that provides “Management Server” services as needed to manage device management client devices that do not support the OMA DM protocol. This component allows MVP to fully support devices that have yet to support the OMA DM protocol.

As used herein, the term “OMA DM server” may be used to represent a server component that provides Management Server” services for device management client devices that do support the OMA DM protocol. A representative embodiment of the present invention may also support the emerging OMA DM firmware upgrade standard. When present, OMA DM protocol may be used for retrieving, setting, and modifying device-specific OMA DM management tree objects for the purpose of provisioning data application parameters. (Note that this latter capability may be limited due to a lack of standard OMA DM “provisioning” objects.)

As used herein, the term “OMA download server” may be used to represent a device management system component that implements V1.0 of the OMA Download protocol. One example of such a device is the mProve PRISM component made by Bitfone Corporation.

As used herein, the term “OMA client provisioning protocol” may be used to represent the protocol used to define various mobile device and application characteristic settings. In a representative embodiment of the present invention, an OMA Client Provisioning document may be delivered to the mobile device using OMA Download. In a representative embodiment of the present invention, a device management server may take over the responsibility for provisioning the mobile device according to the contents of the provisioning document.

As used herein, the term “subscriber instance” may be used to define a single subscriber to the device management system for the purpose of managing subscriber specific provisioning information and establishing communication with a subscriber's device using SMS notifications and WAP Push. (Note that in GSM, the specific mobile device may or may not be known at the time a provisioning or upgrade request is issued.)

As used herein, the term “subscriber class” may be used to define a set of subscriber attributes, common to a set of subscribers. A subscriber class may be used to define provisioning attributes associated with geographic region and a class of subscriber service (e.g., consumer, corporate, pre-paid, basic, premier, elite, etc.). Subscriber class data may be “seen” as subscriber data, but may be maintained and managed separately in a subscriber class device management object to avoid duplication of common information.

A representative embodiment of the present invention comprises a client, a server, and a set of interfaces that may initiate all provisioning and management actions. Such actions may be initiated either from a mobile device, from a web user interface (UI), or from an application program. In a representative embodiment of the present invention, the action may ultimately be serviced via a SOAP API call to a device management server, through which actions are initiated and controlled. External actions that initiate device management system services may include the following:

Using a web UI or, in some cases, a carrier-specific UI, a customer care or point of sale representative in accordance with a representative embodiment of the present invention may enter a subscriber into the carrier's system, resulting in the creation of a subscriber instance record in a device management system. Note that the subscriber's device ID may or may not be known at that time. They may also initiate provisioning of the subscriber's mobile device. Assuming the mobile device is OMA firmware upgrade enabled and/or is equipped with a device management client, the device ID may be known once the device responds to the update operation.

In a representative embodiment of the present invention, a customer at a carrier “self care” web page may be provided with much of the same basic provisioning capability as a customer care representative, but with a carrier portal “look and feel”. Thus, a representative embodiment of the present invention may support the same capabilities via its web services, SOAP API.

In a representative embodiment of the present invention, a subscriber may contact a self care web service from the mobile device, using either the device menu or a browser. Such a service may offer the same basic provisioning capabilities, again through the use of a SOAP API provided by a representative embodiment of the present invention.

In a representative embodiment of the present invention, a “device administrator” may initiate or schedule provisioning for a collection of mobile devices, selected by, for example, device ID, make and model, firmware version, subscriber phone number components, or a combination of selection criteria. Progress of such a request may be tracked via SOAP API “status callbacks” for each affected mobile device, or via a status reporting web UI to display the state of all outstanding and completed requests.

In a representative embodiment of the present invention, a “device administrator” may enter new or updated device capabilities or subscriber class information to a device management server. For example, a firmware upgrade may enable Java capability for a given make and model, or a new multimedia messaging service (MMS) server that is now available for subscribers to the “corporate” plan.

In a representative embodiment of the present invention, a “system administrator” may change device management server operational parameters such as, for example, “workflow control” parameters used to control the times and rate at which “bulk provisioning” operations are released for execution.

In a representative embodiment of the present invention, a “system administrator” may issue requests to create reports for billing, auditing, performance, or diagnostic purposes.

In a representative embodiment of the present invention, a new device/subscriber combination may be detected on the carrier's network. Such automatic device detection allows the carrier to automate device setup using device management services, and also provides the carrier with invaluable information about device usage. New device detection may be accomplished using one of the following means:
Device management system client-based device detection. This may also be referred to as “device detects SIM”. A mobile device may be powered up with a new SIM containing carrier supplied settings to allow the MVP client to contact MVP. The SIM information may include the subscriber MSISDN, data connectivity settings, and a URL. Using these settings, the device management client may pass the MSISDN, IMEI, and the mobile device MMV to a “new device detection” web application as specified by the URL. If the MSISDN and IMEI are valid, the mobile device detection application may invoke the device management system SOAP interface to initialize the mobile device according to the mobile device MMV, and the appropriate subscriber and subscriber class information.
1. SIM-based device detection. This may also be referred to as “SIM detects device”. A “device detection enabled” SIM card inserted into a mobile device may send an SMS message to a preset carrier number, indicating that the subscriber (e.g., IMSI or MSISDN) has placed the SIM in a new or different device (IMEI). In this case, the mobile device make and model may be determined from the IMEI TAC field. The firmware version of the mobile device may not yet be known. If the make and model indicates the possibility that the mobile device has an device management client, the device detection application may attempt to provision the mobile device using the same basic procedure as used by the customer care web UI.

Actions such as the above may be triggered by the device management client, a SIM card, a device management system-provided web UI, a carrier-provided web UI, or a carrier's operations or business support software. Regardless of the source, in a representative embodiment of the present invention, all device management operations may ultimately be serviced via one or more calls to a device management server's SOAP API.

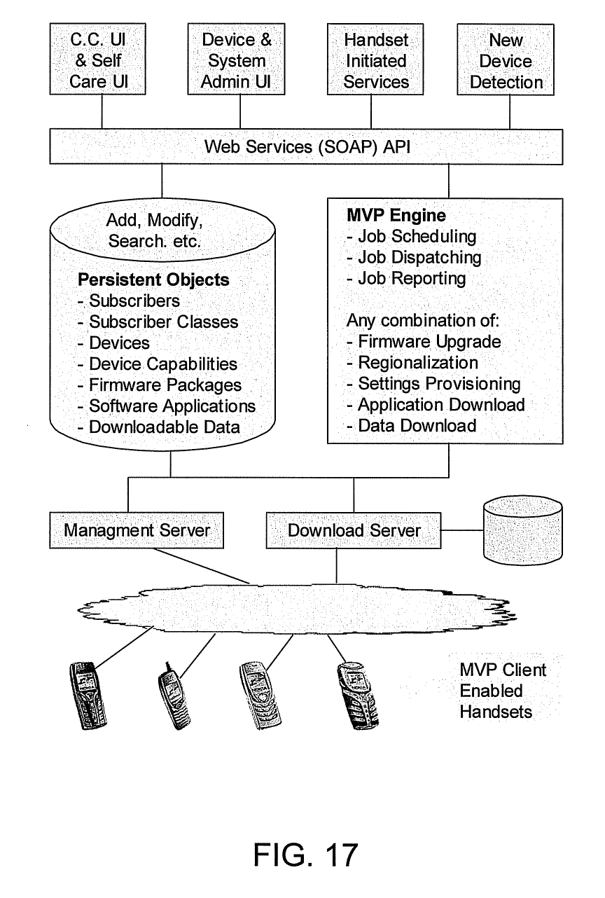

FIG. 17 shows a block diagram illustrating an exemplary set of major components and interfaces of a device management system in accordance with a representative embodiment of the present invention. The “triggering” components are shown on the top row of the diagram, and all of them interface with the device management system using the a SOAP API.

In reference to FIG. 17, the components above the SOAP API may be provided by a representative embodiment of the present invention, but may be augmented or replaced by carrier specific versions. It is also anticipated that carriers may wish to interface their own applications and business logic to a device management system such as that shown in FIG. 17, based upon a published specification for the SOAP API.

A representative embodiment of the present invention may provide a customer care (or point of sale) web user interface (UI). A device management system in accordance with the present invention may provide this web UI to be able to demonstrate a complete set of device management capabilities. In an actual carrier deployment, the services of this web UI may be integrated with the carrier's customer care and point-of-sale (POS) systems. Thus, the components of this UI may be developed to be reused and adapted as part of a carrier-specific integration effort. The UI may be as simple as possible to use, and provide a model for carrier-specific integration efforts.

A representative embodiment of the present invention may provide administrative web UI's to support the following types of services:
A “device administrator” web UI through which device capabilities and subscriber classes may be managed and bulk provisioning operations may be initiated and tracked, and
a “system administrator” web UI for managing overall systems parameters and generating reports for billing, auditing, performance tracking, and problem diagnosis.

A representative embodiment of the present invention may provide handset initiated services. A subscriber may initiate device management services directly from a mobile device/handset via the handset's browser or via a handset menu item. Such subscriber initiated provisioning services may be supported by a device management server in accordance with a representative embodiment of the present invention, and may be augmented by the carrier. These services provide much of the same function as available to customer care or via a self care web page. A representative embodiment of the present invention may provides basic web services for servicing mobile device initiated requests which also serve as a model for carrier provided services to be integrated within the carrier's business logic.

A representative embodiment of the present invention may support new device detection. As described above, new device detection may be accomplished either through a mobile device management client's detection of a new SIM (“device detects SIM”), or through a device detection enabled, proactive SIM (“SIM detects device”).

The “device detects SIM” case may be preferred, as in this case the device management client may provide the complete MMV and device client information needed for a device management system in accordance with the present invention to provision the device without decoding the IMEI and “poking” the device in an attempt to get this information from the device client. To support device management client-based detection, the device management client may involve OEM interfaces to 1) get the carrier supplied data from the SIM card, and 2) to be able to direct the OEM to use the supplied data connection setting for contacting the device management server. The device management effort may validate quickly the extent to which OEM's are willing to support these capabilities.

The “SIM detects device” case may provide an alternative method for device detection, and may be used if the OEM interfaces and services employed by the device management client to implement “device detects SIM” are unavailable. A device management system in accordance with a representative embodiment of the present invention may implement both techniques to gain sufficient device coverage to support automatic device detection and setup.

A representative embodiment of the present invention may support a set of core device management services behind the device management SOAP API. The following is an example of the core elements of a representative embodiment of the present invention:
2. Persistent Objects—comprises a collection of objects that manage information about subscribers, subscriber classes, specific devices, device capabilities, available firmware upgrade packages, and available application and data downloads.
3. Device Management Engine—is the “workhorse” of all device management service requests, including job scheduling, job dispatching, and job reporting.
4. Management Server—provides the OTA protocol support through which a device management system in accordance with a representative embodiment of the present invention verifies and manages the mobile device. An OMA DM protocol may be used when the mobile device management client is operating within a mobile device/handset that supports an OMA DM protocol and the desired device management services. When support for the OMA DM protocol is unavailable or incompatible with the device management system, the device management server may uses protocols specific to the device management system, based on SMS and hypertext transport protocol (HTTP), to manage the mobile device/handset.
5. Download Server—comprises an OMA Download protocol-compliant server that may be used to perform firmware and other downloads to the mobile device. In a representative embodiment of the present invention, the device management system download server may be integrated with 3rd party OMA download servers as well as to support a download server such as that available from Bitfone Corporation.
6. Device Management Client—resides on the mobile handset and works with the device management server to coordinate multiple steps of device verification, firmware upgrade, application provisioning, and download services.

A representative embodiment of the present invention may support device identification and validation. Whenever a previously unidentified mobile device is discovered, a call may be made via a SOAP API to an device management system or carrier provided service to decide what action should be taken. The following are examples of possible situations and device management actions:
The mobile device has been reported as stolen. The carrier's business logic may handle such cases, and may simply tell the device management system to ignore the device if stolen.
The mobile device may in or out of warrantee. The carrier's business logic may handle such cases, and may tell the device management system not to update any firmware if the device is out of warrantee.
The mobile device is already registered to another subscriber of this carrier. By default, the device management system may assume that this is a borrowed mobile device, and may not provision it. In the case of a subscriber with multiple SIM's, this default may be overridden by carrier business logic to allow the mobile device to be provisioned, if not already done.
The mobile device is not registered with the device management system. The mobile device may be a borrowed device or a new device for this subscriber. The default action by the device management system may be to prompt the mobile device user before any attempt is made to assign it to the subscriber and provision it accordingly. Note that if the subscriber has not yet been assigned to any mobile device, the device management system may provide the option of binding the first observed valid mobile device to the subscriber, without prompting.
The device is already assigned to this subscriber. In this situation, the mobile device is most likely a second mobile device, e.g., one the subscriber uses on weekends, The mobile device may be provisioned according to the subscriber's attributes if this has not already been done.

In the absence of a carrier provided policy service, a device management system in accordance with a representative embodiment of the present invention may default to the following assumptions:
No check may be made for stolen or out of warrantee devices, so the device management system may assume the mobile device is not stolen and is still within warrantee.
If the mobile device is already registered to a different subscriber, the mobile device may be assumed to be borrowed and may not be assigned to or provisioned for this subscriber.
If the subscriber record shows no previously assigned mobile device and the subscriber record is set to accept the first observed and previously unclaimed device, the mobile device may be assigned to the current subscriber and provisioned accordingly.
If the subscriber record shows no previously assigned mobile device and the subscriber record is not set to accept the first observed and previously unclaimed mobile device, the mobile device user may be prompted before the mobile device is assigned and provisioned.
If the subscriber record already shows a previously assigned mobile device, and the mobile device is currently unassigned, the mobile device may either be borrowed or another mobile device that the subscriber has acquired. In this case, the mobile device user may be prompted before the device is assigned and provisioned.

If the mobile device is already assigned to the current subscriber, the device may be provisioned according to the subscriber's attributes if this has not already been done.

A representative embodiment of the present invention may support persistent objects. A device management system in accordance with a representative embodiment of the present invention may provide the following persistent objects, each of which have the capability to enumerate, retrieve, search for, add, delete, and modify a specific type of object:
Subscriber Instance Object
Subscriber Class Object
Device Instance Object
Device Capability Object
Firmware Definition Object
Download Object

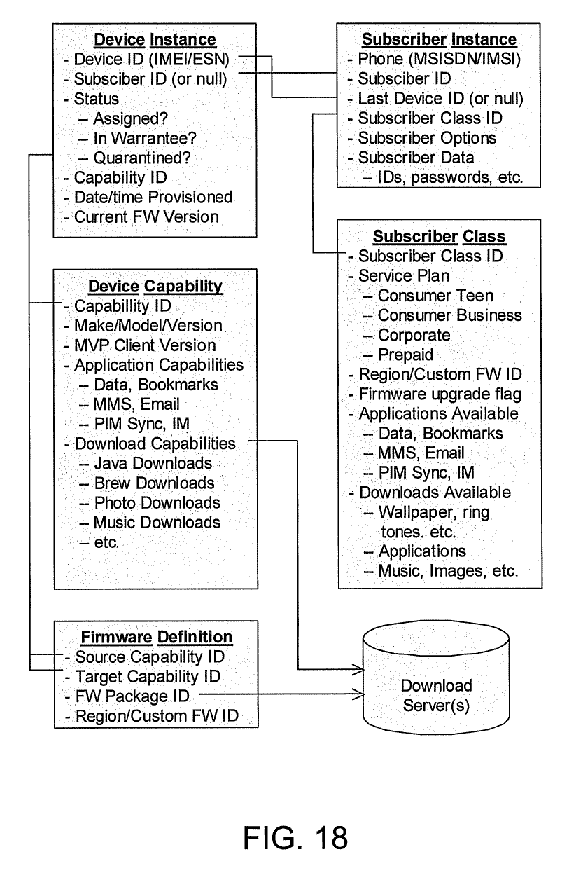

FIG. 18 is a block diagram illustrating an exemplary set of the principal properties of each object and the inter-relationship between objects, in accordance with a representative embodiment of the present invention. Although a variety of implementations of persistent object may be employed in a device management system without departing from the spirit and scope of the present invention, it may be useful to view each object's property data as a table in a relational database. Tables from different object may be related to each other by common fields such as, for example, device ID (i.e., “DevId” in the OMA DM protocol specifications) or subscriber ID.

A representative embodiment of the present invention may support a subscriber instance object. The subscriber instance object may defines a single subscriber to a device management system for the purpose of managing subscriber specific information and establishing communication with a subscriber mobile device using SMS notifications and WAP Push. The properties of this object may include, for example:
Mobile phone number (MSISDN, IMSI MDN, or MIN)—This value uniquely identifies a single carrier subscriber and may be used to send SMS messages for OMA DM Bootstrap and Session Notification. Note that for GSM, MSISDN may be preferred, but IMSI may be the only identifier available from the mobile device in some situations.
Subscriber ID—The subscriber ID may comprise a unique ID for this subscriber, that may be used to relate this subscriber to any mobile devices that the subscriber has used. This value may be used in lieu of the mobile phone number, which may change.
Last Seen Device ID—The last seen device ID may comprise the IMEI or ESN that a device management system has most recently associated with a subscriber. This property may be omitted when the device ID is not known to the carrier. Any empty value may be replaced by the first legitimate device ID when identified (i.e., actually read from the mobile device) by a device management system. The property may also be updated if the user uses a different device and allows/requests it to be provisioned by the device management system. It is desirable not to mistakenly provision a borrowed or stolen device.
Subscriber Class ID—The subscriber class ID may comprise a unique ID that ties the subscriber to the subscriber's class information. Subscriber class information may be seen as properties of a subscriber object, even though the class properties may actually be managed by the subscriber class object. Note that a subscriber's “regional” and “class of service” settings may be determined by the subscriber class.
Subscriber Options—The subscriber options may specify subscriber-specific options such as, for example, the option to accept and provision first detected device, as discussed above under device identification and validation.
Subscriber-Specific Data—Subscriber-specific data may comprise such item as, for example, user IDs and passwords that may be managed via a map of name/value pairs that provide data values for “placeholder” names. For example, the placeholder name “#POP_PASSWORD#” might be used to retrieve a password for a subscriber Email account.
Date/Time Modified—A date/time modified value may indicate when this object was last changed, which may indicate that the subscriber's mobile device or devices may need to be updated. This value may be compared with a device instance object's “date/time updated” value to determine if the subscriber's mobile devices are up-to-date.

In a representative embodiment of the present invention, the subscriber instance object may provide “getters and setters” for all simple properties. In a representative embodiment of the present invention, methods may be provided for, “add”, “find”, “enumerate” and “delete”, as well as for the following public (e.g., pseudo) methods for managing subscriber-specified name/value pairs:
setValue (name, value)
value getValue (name)
deleteValue (name)

A representative embodiment of the present invention may support a subscriber class object. The subscriber class object may define a set of subscriber attributes which are common to a set of subscribers. A subscriber class may be used to define provisioning attributes associated with a geographic region and a class of service for a given class of customer (e.g., consumer, corporate, pre-paid, basic, premier, elite, etc.). Subscriber class data may be seen as subscriber data, but may be maintained and managed separately in a subscriber class object. The properties of this object may include, for example:
Subscriber Class ID—This value may uniquely identify the specific subscriber class and may be used within a subscriber instance object to locate the associated class information.
Class Name—This value may provide a “friendly” name for the subscriber class that may be used to easily identify the region and class of services defined by this subscriber class such as, for example, “UK consumer—teen” or “France corporate—elite”.
Regional or Custom Firmware ID—The object may identify the specific regional or custom firmware to be used for subscribers to this class.
Firmware Upgrade Flag—This value may indicate that subscribers to this class may be included in bulk firmware upgrade operations.
Applications Available—This data specifies what device data services are to be provisioned for subscribers in this class, and if specified, the service provisioning data values to use to provision each authorized service. A representative embodiment of the present invention may provide data provisioning for the following data services:
   Basic data service (a prerequisite for other services)
   Bookmarks
   MMS service
   PIM Sync
   Email
   Instant Messaging
Downloads Available—This object may specify a list of generic (i.e., non device specific) names of applications and data to be downloaded to each subscriber's mobile device, to the extent the mobile device can support that type of application or data. Note that a given application or data object may have several versions for different mobile device types and firmware versions. Thus, the generic download name may be combined with a specific set of mobile device capabilities to locate the correct download version for a specific set of mobile device capabilities. Once the user's mobile device and version information is detected, only the downloads supported by the actual device instance may be processed.
Date/Time Modified—This value may record when this object was last changed, which may indicate that any associated subscriber's mobile device or devices may need to be updated. This value may be compared with a device instance object's “date/time updated” value to determine if the subscriber's devices are up-to-date.

The Subscriber Class object in a representative embodiment of the present invention may provide “getters and setters” for all simple properties. A representative embodiment of the present invention may provide methods for, “add”, “find”, “enumerate” and “delete”, as well as the following public (i.e., pseudo) methods for managing client provisioning and authorized download data:
setProvisionData (applicationName, provisioningDataOrNull)
provisioningDataOrNull getProvisionData (applicationName)
setDownload (genericDownloadNamename, genericURL)
genericURL getDownload (genericDownloadNamename)
enumeration getDownloads (expression)
deleteDownload (name)

A representative embodiment of the present invention may support a device instance object. The device instance object may represent a single mobile device identified on the mobile network by its “DevId” (e.g., IMEI or ESN). Under normal circumstances, each device instance may be associated with a specific subscriber MSISDN, IMSI, MDN, or MIN, (except for “quarantined” mobile devices that may be discovered on a GSM mobile network). The device instance object may manage and maintain the following properties:
Device ID—This may comprise an IMEI or ESN that uniquely identifies the mobile device. Whenever a new mobile device is identified by a device managemenht system in accordance with the present invention, a device instance object may be created with “quarantined” status, until it can be determined what subscriber (if any) should be associated with the mobile device.
Subscriber ID—If set, this value links the mobile device to the subscriber instance object deemed to be the owner of the mobile device. If the current subscriber's “last device” value is not set, a representative embodiment of the present invention may assume that the first legitimate mobile device to respond to the subscriber's SMS number is the subscriber's mobile device, and may associate the mobile device with that subscriber by setting the “last device” value in the subscriber instance object. If the “last device” already has a different device ID, the new mobile device may represent a borrowed or alternate device. In this case, a representative embodiment of the present invention may prompt the mobile device user to ask whether or not to provision the mobile device according to the subscriber's settings, options, and data values for the new mobile device.
Device Status—This property may initially be set to “quarantined”, until the device management system can determine whether the mobile device is stolen, in or out of warrantee, borrowed from a user subscribed to another carrier, or linked to a specific subscriber instance within the current carrier. If a device management system in accordance with a representative embodiment of the present invention discovers a subscriber using a device “owned” by another user with the same carrier, the device management system may assume by default that the mobile device is borrowed, and the device management system may not attempt to perform any further actions for the subscriber currently using the mobile device. Information regarding “stolen” or “out of warrantee” may make use of a carrier-supplied SOAP callback. If this callback is not provided, a device management system in accordance with a representative embodiment of the present invention may assume that the mobile device is not stolen and is still within its warrantee period (i.e., it is permitted to receive firmware updates). Mobile devices that are “out of warrantee” but otherwise legitimate, may still be provisioned according to their current firmware capabilities.
Capability ID—This property may be used to link the device instance to a device capability record that fully describes the capabilities of the mobile device, based on the make, model, and firmware version. In some cases, it may not be possible to find a device capability object that corresponds to the specific device make, model, and firmware. In such a case, a representative embodiment of the present invention may attempt to find a generic capability object based strictly on make and model. If no match can be found the capability ID may be left empty, and the device management system may make no attempt to provision the mobile device.
Date/time Last Provisioned—This property may contain the date and time that the mobile device was last provisioned by device management system. If the mobile device has not been provisioned, this value may be empty. This value may be compared to the date/time modified value in the associated subscriber instance object to determine if anything has changed since the last provisioning operation.
Current Firmware Version—This property may identify the firmware last upgraded on the mobile device. If the mobile device has yet to receive any firmware upgrades, the value may be empty.

Note that a subscriber may end up using several mobile devices over a period of time. A representative embodiment of the present invention may make no provision for “cleaning out” unused mobile devices, other than providing the date/time information mentioned above.

The device instance object of a representative embodiment of the present invention may provide “getters and setters” for all simple properties. A representative embodiment of the present invention may provide methods for, “add”, “find”, “enumerate” and “delete”.

A representative embodiment of the present invention may support a device capability object. The device capability object in a representative embodiment of the present invention may describe the capabilities of a specific class of device as identified by its make, model, and firmware version. Capabilities such as “supports Java MIDP 2.0”, or “supports Email” may be dependent on firmware version, which may be a combination of “version” information such as firmware version, software version, and “flex” version. The device capability object may manage and maintain the following properties for each unique combination of device make, model, and version:
Capability ID—This value may uniquely defines the specific capability object and may be used to link a device instance object to its associated device capability object.
Make/Model/Version—This property may define the make, model, and version information used with this specific set of device capabilities. It is possible to create a “generic” capability object by leaving the version data unspecified. This may be an appropriate compromise when it is known that all versions of a given make and model support a common subset of capabilities.
MVP Client Version—This property may define the specific version of the device management client in use, in case this information can not be determined from other available version information.
Application Capabilities—This property may be used to specify what device data services are supported by this device MMV. If a subscriber (class) object shows that a subscriber is to be provisioned for a service, and the application capabilities show that the device type is able to support the service, a representative embodiment of the present invention may generate the appropriate provisioning data to provision the union of the services selected and services available on the mobile device. The specific data services that can be provisioned by device management system may include the following:
   Basic data service (a prerequisite for other services)
   Bookmarks
   MMS service
   PIM Sync
   Email
   Instant Messaging
Download Capabilities—This property may specify a list of applications and data that may be downloaded to a mobile device of this make, model, and version. This list may be matched against the list of selected downloads in the subscriber class object to create a list of downloads to be performed for a specific device and subscriber combination.

The Device Capability in a representative embodiment of the present invention object may provide “getters and setters” for all simple properties. Methods may be provided for “add”, “find”, “enumerate” and “delete”, as well as the following public (i.e., pseudo) methods for managing client provisioning and authorized download data:
setProvisionFlag (applicationName, true/false)
true/false getProvisionFlag (applicationName)
setDownload (name, URL)
URL getDownload (name)
enumeration getDownload (expression)
deleteDownload (name)

A representative embodiment of the present invention may support a firmware definition object. A firmware definition object may be used to manage the data that maps source and target firmware package to specific device capabilities. The purpose of this object is to add a general capability to cover the following cases:
Given a source firmware version and a “role”, find the current target firmware package.
Given a source firmware version and a “role”, find the firmware package that upgrades the device firmware to a specific target firmware version, which could be earlier or later than the source firmware version.
Given a source firmware version and a “role”, find the firmware package that upgrades the device firmware to a specific target firmware version as identified by a base firmware ID (e.g., regional or custom firmware for a specific class of subscriber).

The firmware definition object may be employed as a “front end” to the functionality provided by an existing device management tool, such as the PRISM tool from Bitfone Corporation. The firmware definition object may be used to “front end” a download server. In a representative embodiment of the present invention, the firmware definition object may be defined to manage the following properties:
Source Capability ID—This property may identify a specific source version by its device make, model, and version capability object ID.
Target Capability ID—This property may identify a specific target version by its device make, model, and version capability object ID.
Regional or Custom Firmware ID—This property may identify the firmware as belonging to a class of regional or customized firmware versions. Each region may employ its own series of firmware packages for each mobile device/handset make and model supported for that region. The same may hold true for “custom” firmware as well.
Firmware Package ID or URL—This property may Identify the specific firmware package to use when the above three fields are matched.

Note that the firmware definition object may allow separate firmware packages to be found for a specific combinations of source, target, and base firmware IDs.

The Firmware Definition object of a representative embodiment of the present invention may provide “getters and setters” for all simple properties. Methods may be provided for “add”, “find”, “enumerate” and “delete”, as well as the following public (i.e., pseudo) methods for looking up firmware packages:
firmwareObj getCurrentFirmware (sourceID, role)
firmwareObj getCurrentFirmware (sourceID, BaseID, role)
firmwareObj getTargetFirmware (sourceId, targetID, role)

Note that the above methods may be replaced by a general “find” method, but is documented above to show examples of the lookup parameters that may be used.

A representative embodiment of the present invention may support a download object. An additional download object (not shown in FIG. 18) may be used to manage information about available downloads and specific device capabilities. Downloads may be identified by non-device-specific, “generic” names in the subscriber class object. To find the right download package for a given set of device capabilities, the download object may support the following properties:
Generic Download Package Name—This property may comprise a generic package name, which may be unique. One way to ensure uniqueness of both the generic and specific downloads may be to use generic and version specific variations of the URL as follows:
   http://download.foo.com/ExpenseCalculator
   http://download.foo.com/ExpenseCalculator/Nokia7650
Device Capability ID—This property may identify a specific target set of device capabilities by its capability object ID.
Download Package URL—This property may comprise a universal resource locator (URL) that uniquely locates the download server and the package to be downloaded.

The download object of a representative embodiment of the present invention may provide “getters and setters” for all simple properties. Methods may be provided for “add”, “find”, “enumerate” and “delete”, as well as the following public (i.e., pseudo) methods for looking up firmware packages:
URL getDownloadURL (genericDownloadName, deviceCapabilityID)

Note that the above method may be replaced by a general “find” method, but is documented above to show examples of the lookup parameters that may be used.

As described above with respect to FIG. 17, a representative embodiment of the present invention may comprise a device management server engine. Once the device management objects described above are populated with the necessary instance data, the device management server “engine” may operate on that data to provide services from the following additional components as described in this section:
Deployment Manager
Deployment Scheduler
Deployment Broker
Bundle Manager
Management Server
Download Server
Report Manager
Configuration Manager

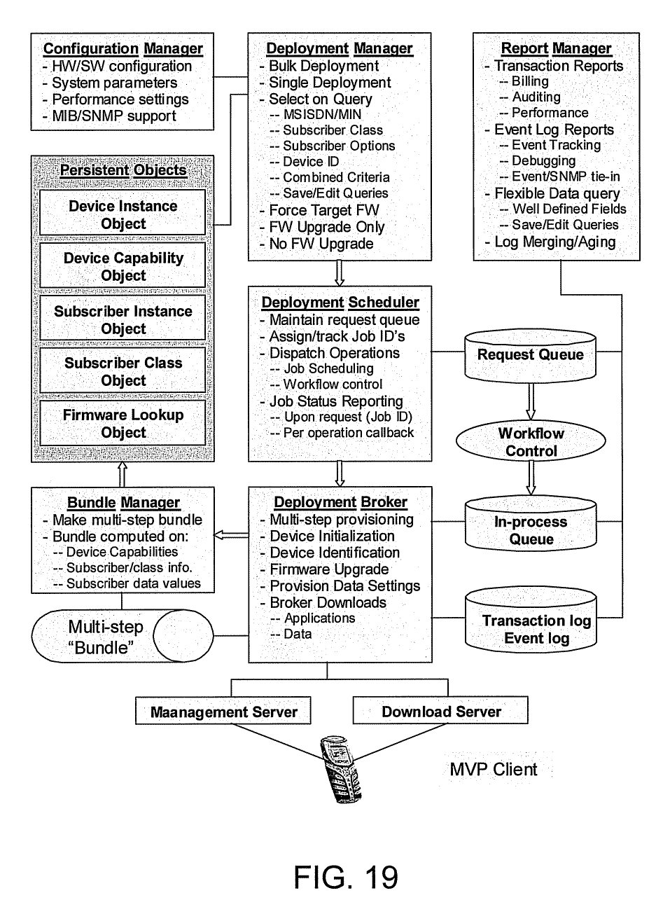

FIG. 19 is a block diagram that illustrates deployment, reporting and configuration components of an exemplary device management server engine, in accordance with a representative embodiment of the present invention. FIG. 19 shows the principal functions of each component and the general flow among the principal components. Each component is described in greater detail in the follow sections.

A representative embodiment of the present invention may comprise a deployment manager. The deployment manager of a representative embodiment of the present invention may provide services for making provisioning requests to be performed by device management system. Such requests may ultimately be resolved to one of more specific subscriber ID's, which may be specified directly, or via a multipart query expression (e.g., all subscribers associated with devices with a specific make, model, and version, AND subscribed to the “Corporate” subscriber class).

Two forms of request may be provided, a simple form, designed to be used from a customer care or self-care UI or web service, and another to perform more complex requests, or bulk requests involving a set of subscribers, most likely derived via some multipart query expression.

A representative embodiment of the present invention may support simple subscriber provisioning. In the single subscriber provisioning case, the provisioning request may take the following general form:
jobID provisionSubscriber (phoneNumber, [makeModel], [Options], [callbackURL])
   where the individual parameters are described as follows:
phoneNumber—This parameter may identifies the subscriber whose mobile device is to be provisioned. If the subscriber has not been associated with a specific device (e.g., was provided with a SIM card only), the device ID may not be available in the subscriber instance record.
makeModel—This parameter is an optional parameter that A representative embodiment of the present invention may use to determine whether or not the mobile device is likely to be able to support the OMA DM protocol required for device management support.
Options—This parameter may identify an optional object containing more specific information about the operations to be performed or skipped. It may contain additional user-specific parameters, or may specify that certain operations be skipped (e.g., skip the provisioning of email and personal information manager (PIM) synchronization (Sync)).
callbackURL—This parameter is an optional parameter that may be used to specify a location to which representative embodiment of the present invention may issue a SOAP API “status report” upon completion of the operation.
jobID—This parameter may contain a return parameter that may uniquely identifies this request. This parameter may be included in all status reports, whether via callback or an explicit status request.

If a mobile device corresponding to the makeModel parameter is known not to support the device management client, the device management request may be aborted immediately, without sending useless SMS messages trying to communicate with the mobile device. If the makeModel parameter does indicate support for device management according to a representative embodiment of the present invention, or if the make and model is not specified, a representative embodiment of the present invention may attempt to contact an device management client in the mobile device to discover its identify and MMV information. Owners of self-care web pages may wish to specify make and model to try to avoid unnecessary SMS traffic and possible misunderstanding, concerning the level of device management support for the mobile device.

A representative embodiment of the present invention may also support extended subscriber provisioning. In the single subscriber provisioning case, the provisioning request may take the following general form:
jobID provisionSubscriber (queryExpression, [Options], [callbackURL])
   where the individual parameters are described as follows:
queryExpression—This parameter may identify one or more subscribers to be provisioned. The Deployment Manager component of a representative embodiment of the present invention may resolve the query expression into a list of specific subscriber phone numbers. Each subscriber request may represent a single provisioning operation. Such operations may maintain their association with the original request, via the job ID assigned to the request.
Options—This parameter is an optional parameter that may be used to alter the default firmware upgrade behavior. The default behavior may be to always schedule the request as soon as possible, get the MMV directly from the device, and to upgrade the mobile device firmware to “current” as needed during device provisioning. This parameter provides for the following options:
   1. startDateTime—This property is an optional property that may be used to specify a time after which the provisioning request may be started. If not specified, the request may be started immediately, subject to system-wide workflow control parameters.
   2. sourceFirmware—This property is an optional property that may provide a list of one or more source firmware identifiers, restricting the firmware upgrade to only those firmware identifiers.
   3. MMV—This property may be used to indicate that the MMV has already been determined (e.g., by the “device detects SIM” method) and that a mobile device identification step may be bypassed.
   4. targetFirmware—This property may be used to force a specific firmware version rather than the “current” firmware.
   5. skipUpgrade—This property may be set to indicate that the device management system may skip the firmware upgrade step and provision the device according to it current firmware capabilities.
callbackURL—This parameter may be used to specify a location to which a device management system in accordance with a representative embodiment of the present invention may issue a SOAP API “status report” upon completion of the operation. The callback may be invoked for each operation in the job.
jobID—This parameter is a return parameter that may be used to uniquely identify a request. This parameter may be included in all status reports, whether via callback or an explicit status request.

In a representative embodiment of the present invention, the deployment manager may pass the job ID and the list of subscribers directly to the deployment scheduler, which handles all scheduling, workflow control, dispatching, bookkeeping, and status reporting tasks.

A representative embodiment of the present invention may support status reporting. Once a simple or extended provisioning request job is passed on to the deployment scheduler, the deployment scheduler may handle all status reporting callbacks. However, the deployment manager in a representative embodiment of the present invention may also provide an interface by which the current status of a job may be retrieved from the transaction log. The following request may be used to return an array of status objects, one for each operation in the original request:

statusArray getStatus (jobID);

where each object in status array contains a subscriber ID, phone, device ID (if known) and the current status of the job (e.g., scheduled, dispatched, in progress, in retry, completed, etc.). For jobs completed in error, an additional, error code and error code dependent message may also be included to pass back any details that may be needed to take corrective action.

A representative embodiment of the present invention may comprise a deployment scheduler. The deployment scheduler of a representative embodiment of the present invention may do all the “heavy lifting” for the deployment manager, which may act mainly as the external interface for initiating provisioning requests. The interface to the deployment scheduler may be identical to the extended and status reporting interfaces of the deployment manager, with the single exception that any query expression may resolve into a list of subscribers as follows:
jobID provisionSubscriber (subscriberList, [Options], [callbackURL])
   where all other parameters are as defined for the Deployment Manager.

The main job of the deployment scheduler in a representative embodiment of the present invention is to handle request scheduling, workflow management, operation dispatching, and status reporting. The deployment scheduler runs off a timer as well as when called from the deployment manager. Once a request is placed in the request queue, the deployment scheduler may monitor the request schedules and the current workload to determine when to dispatch more operations from the request queue to the in process queue.

The general flow of work from the deployment scheduler's point of view may be summarized as follows:
1. The in-process queue is monitored for completed operations. Status callbacks may be issued for each completed operation, if a callback was specified in the original request. A “final” transaction may be written to the transaction log and the completed operation may be removed from the in-process queue. When the last operation of a specific job is completed, the request may also be logged as complete and the request may be removed from the request queue.
2. The current workload and workflow configuration parameters may be reviewed to determine if these parameters allow additional operations to be dispatched from the request queue to the in-process queue. If workflow controls permit, an “appropriate” number of operations may be moved from the request queue to the in-process queue. Note that the original request may be maintained in the request queue until all associated operations have been completed.

Whether or not any operations have been dispatched, the deployment scheduler may invoke the deployment broker, to give it a chance to forward its outstanding workload.

A representative embodiment of the present invention may comprise a deployment broker. The deployment broker may be responsible for managing all steps in the provisioning process. The broker's workload may be predetermined by the deployment scheduler through the action of moving requested operations from the request queue to the in-process queue. The broker looks at the in-process queue for new operations to be processed and to maintain state for operations already in progress. The deployment broker may be given an opportunity to run every time the scheduler runs, but may also use its own timer should it need to run more often.

Provisioning operations in a representative embodiment of the present invention may progress through a series of “steps” along the following lines:
1. If the subscriber instance does not contain a specific device ID, or if the device identified does not indicate prior provisioning activity, the deployment broker may assume that the mobile device needs to be bootstrapped to be able to initiate a provisioning session. In this case, the deployment broker may initiate a bootstrap request with the OMA DM service, may set the operation state to “initiating bootstrap” and may take no further action for a short period of time to let the bootstrap operation get to the mobile device. In an alternative embodiment in which the device management client is the recipient of the bootstrap message, the waiting may be eliminated. Also note that a representative embodiment of the present invention may operate without a DM service, using an SMS message to cause the mobile device management client to initiate detection, upgrade, and download operations.
2. If the MMV is already known, the deployment broker may continue with step 4. If the MMV is not already known, the deployment broker may invoke the OMA DM service to retrieve the device ID, make, model, and appropriate software and firmware version information. The deployment broker may also send a URL to the mobile device through which the mobile device may contact the deployment broker for “further instructions” upon completion of a deployment broker provisioning step. This URL “callback” from the mobile device provides the basic mechanism by which the deployment broker asks the mobile device to perform subsequent DM sessions or OMA download operations, without the need for an additional SMS push notification.
3. The device ID, make, model, and version information may be used to update any pre-existing device instance object, or to create a new one if none currently exists for this device ID. Device and subscriber validation may be performed as described under device identification and validation, above. If the mobile device is deemed valid for this subscriber, the device instance may now be associated with the current subscriber ID.
4. At this point, the device and subscriber ID, and all available make, model, and version information may be known. The deployment broker may now attempt to find a matching “specific” or “generic” device capability object from which the deployment broker can determine how to upgrade and/or provision the device. If no such object is found, the provisioning of this device may end. However, the mobile device has now been positively identified and associated with the subscriber, providing the carrier with important device utilization information.
5. Once a matching device capability object is found for the MMV to be provisioned, the deployment broker may invoke the bundle manager component to create the job steps required to execute this job, for this subscriber, using the matching set of device capabilities. The bundle manager returns a “bundle” of comprising firmware upgrade, download and provisioning steps to be performed in sequence, specific to these parameters.
6. If the bundle specifies a firmware upgrade step, it is the first step in the bundle. The bundle information specifies the appropriate firmware object so that the deployment broker may proceed directly into the firmware upgrade process. Another DM session may be started for the purpose of transmitting the appropriate URL to the device management client and initiating the download/update sequence via a DM Exec command (e.g., as specified in the emerging OMA DM firmware upgrade standard). Upon completion of the upgrade, the device management client may post the deployment broker's URL to report status, and await “further instructions”.
7. Once the firmware is upgraded to a known set of capabilities, the device management system is ready to perform any remaining provisioning operations contained in the bundle. This may include application and data download URL's to be performed, as well as the provisioning of settings used by data-enabled applications such as browsing, bookmarks, MMS, Email, etc. The bundle may contain URL's needed for each download of the subscriber settings to be provisioned on the device. Data application provisioning data may be presented as a set of device specific OMA DM operations, or a set of standard OMA Client Provisioning “application characteristics”.
Other representative embodiments of the present invention may deliver client provisioning information in OMA Client Provisioning V1.1 format, but may deliver it to the mobile device management client using an OMA Download protocol. The device management client may process the client provisioning information, and may distribute the settings to appropriate settings locations within the mobile device using manufacturer-specified “wrapper” functions.
8. An OMA DM session may not be needed for each download operation defined in the bundle. Each URL may be transmitted back to the device management client within the deployment broker's response to the device management client's “status post”.
9. Upon receiving the device management client post indicating completion of the last step specified in the bundle, the deployment broker may respond to the device management client that there are no more steps to perform, and the multi-session upgrade/provisioning operation may be marked as completed.

As each deployment broker step proceeds, the deployment broker may maintain the current state of the entire operation within the in-process queue, so that if the process is interrupted, the process can be restarted at the step that failed.

Deployment broker operation relies heavily on the ability to receive the “step completion post” from the device management client and the ability to ask the device management client to perform another subsequent operation as part of the deployment broker's response. The deployment broker also may employ a DM-service provided “session in waiting” feature, that allows the deployment broker to ask the device management client to start a DM session, using the out-of-band post request response feature, to avoid initiatign all DM sessions with a separate SMS notification message. Note that this feature may also be used to cause the device management client to initiate a DM session in response to a device management client invocation of a web page or web service that uses a DM session to complete the request.

A representative embodiment of the present invention may comprise a bundle manager. The bundle manager in a representative embodiment of the present invention may create provisioning bundles dynamically, given a subscriber instance object, a device capability object, and a list of job steps requested by the job Options object. The subscriber instance may provide access to subscriber-specific data values, as well as access to all common download information and provisioning data contained in the subscriber class object associated with the subscriber. The device capability object may define the provisionable capabilities of the device, and specific download versions that the device is able to support.

If the firmware upgrade job option is set, the bundle manager may invoke the firmware object to find the firmware for the MMV in the device capability object, consistent with the various job options (selected source firmware, target firmware, skip firmware upgrade, etc.). If firmware upgrade has been selected and there is an appropriate firmware upgrade for the specified parameters and options, the bundle manager may set up the firmware upgrade as the first step in the bundle.

The bundle manager may then append additional steps to the bundle according to the target mobile device capabilities, subscriber settings, and job options. If the bundle contains “placeholder” values, the bundle manager may substitute the necessary subscriber specific values for all “placeholders” (e.g., replacing “#POP_USERID#” with “bdaley”). The resulting bundle may then be passed back to the deployment broker in a form that allows easy access to each individual step in the bundle.

A representative embodiment of the present invention may comprise a management server. The management server in a representative embodiment of the present invention may have two implementations, a management service for managing mobile devices/handsets that cannot support the device management client using OMA DM, and a management service that supports OMA DM. In the first case, the DM service may send a unique SMS message to the mobile device/handset that tells the device management client to contact the device management server and provide MMV information. Through a specific HTTP/HTTPS interchange of messages, the device management server in a representative embodiment of the present invention may communicate the same information to the device management client as would have been communicated had the device management client been able to use the OMA DM protocol.

In the second case, the device management client is compatible with the OMA DM protocol. The device management service may support the specific features employed by a representative embodiment of the present invention, most specifically those employed by the deployment broker. The interface to the DM service may support interfaces equivalent to the following functionality:
1. Bootstrap a DM capable mobile device given its SMS phone number (MSISDN/MDN). Support may be provided for both the plain profile and the WAP “w7” application characteristic.
2. Send a DM package to a specific mobile device consisting of a mix of Get, Add, Delete, Replace, Confirm Alert, Notify Alert, and Exec commands to support the emerging OMA DM firmware upgrade standard.
3. Retrieve values received from DM Get commands, including Get commands directed at interior nodes as well as leaf nodes.
4. Retrieve values provided by the device management client within the device management client's DevInfo object, and any device management client status information sent to the device management server using, for example, Alert 1224, (e.g., as used for status reporting from a completed firmware upgrade).
5. Ability to “queue” a DM package such that no SMS notification message is sent to the device. Instead, the DM service may expect the mobile device to initiate the session. The flow may be exactly the same as for a server-initiated session, except that no SMS notification message may be sent.

A representative embodiment of the present invention may comprise a download server. The download server in a representative embodiment of the present invention may be any OMA Download compliant download server able to support adequate security for firmware and application download operations. A representative embodiment of the present invention may be able to support more than one download server, perhaps as many as two or three, including the use of components for firmware management and download such as the mProve and PRISM components from Bitfone Corporation.

A representative embodiment of the present invention may comprise a report manager. A representative embodiment of the present invention may provide for two types of reports, both of which may be based on fielded data maintained across server nodes in a shared database. One type of report may be based on the device management system transaction log, which logs each provisioning transaction. The “transaction log” may be used for status reporting on pending, in-process, and completed transactions. These transactions may provide specific date, time, subscriber, device, operation performed, requesting user, completion statue, and any related transaction information that may be needed for billing, auditing, summary error tracking, and performance monitoring.

Another type of reporting is a more detailed “event” log that is roughly analogous to the UNIX syslog and supports various “levels” of logging, commonly referred to as ALERT, ERROR, WARNING, and DEBUG. In a representative embodiment of the present invention, logging levels may be changed to gather more or less event information, depending on the need for such information. The most intense level of logging, DEBUG, may rarely be used in a production environment, except for short periods of time to diagnose serious system problems. Certain levels of logging, e.g. ALERT, ERROR, and WARNING messages may also trigger an simple network management protocol (SNMP) trap to alert a carrier's network management system.

To support integrated reporting via the report manager, a representative embodiment of the present invention may maintain an event log as a database shared across all MVP server nodes. Like the transaction log, the data may be fielded to allow data selection and reporting based on date time, operation type, logging type, initiating user, or even specific device(s) or subscriber(s) when such information is known at the time the message is logged.

The report manager may provide interfaces that define and generate reports from either the device management system transaction log or the device management system event log. Data to be reported may be specified using a query expression to select the data to be reported, and an ordered list of fields to be captured. Report specification as well as query expressions may be saved, retrieved, used, copied, and modified to produce both repeatable and flexible reports

Reports may be generated on demand in CSV format, suitable for export to an external system for billing and or analysis, or displayed by a separate report viewing web UI.

A representative embodiment of the present invention may comprise a configuration manager. The configuration manager in a representative embodiment of the present invention may provide a central source for setting and retrieving variable system parameters. Configuration data may be maintained as a set of name/value pairs, both within the device management system database and in memory. Most requests to retrieve configuration data may be serviced from memory, with the data updated from the common configuration database “periodically” (e.g., every five minutes). Retrieving configuration values may be deliberately optimized at the expense of a minor delay before all nodes respond to a configuration change. Note that the update period may also be changed.

Many configuration parameters may be defined for use in a device management system in accordance with a representative embodiment of the present invention. Below are identified only a few of those configuration parameters that are employed by features described above. It should be noted that a greater or lesser number of configuration parameters, or different configuration parameters may be employed, without departing fromt eh spirit and scope of the present invention. An exemplary set of configuration parameters may include:
1. Workload Control Parameters—These parameters may be employed to prevent both system and network overload during both normal system operation and also during peak periods. Specific parameters may include the following
   a. Maximum number of outstanding “in-process” operations
   b. Number of SMS messages allowed per unit time
   c. Number of individual device operations dispatched per unit time
   d. Number of individual device operations dispatched from a single request before dispatching operations from other requests.
   e. Number of operations in a request above which the request may be considered to be a “bulk provisioning” request.
   f. Definitions of peak periods during which no new operations may be dispatched from the request queue to the in-process queue.
2. Operation Retry Parameters—These parameters may be employed to control operation retry behavior if an operation encounters a specific error, or simply times out:
   a. Number of retries before the operation is failed
   b. Time interval between retry attempts
   c. Time an operation is permitted to remain “in-process” before the operation is failed.
3. Carrier specified URL's—These parameters define URLs for reporting and invoking optional, carrier specific business logic, including:
   a. URL to be posted on severe serious error conditions or anomalies
   b. URL to be invoked via SOAP callback to provide device warrantee information
   c. URL to be invoked via SOAP upon discovery of a new, unclaimed device to determine whether the device might be stolen, record device usage statistics, or direct the device management system to automatically accept or reject the device.

A representative embodiment of the present invention may comprise query manager. Several of the device management system components discussed above make reference to a “query” expression to select the items to include in some request. Rather than burden each of the previous component discussions with query considerations, the concept of a query manager component is introduced here. A query manager in accordance with a representative embodiment of the present invention may accept query expressions such as, for example:

| | | | |
|---|---|---|---|
| FieldName1 | EQ | Value1 | AND |
| Fieldname2 | LIKE | Value2 | OR |
| Fieldname3 | NE | Value3 | |

Whenever a field name is not unique across objects (e.g., in tables) it may be prefixed by its object name (e.g. DeviceInstance.SubscriberID). Queries may be used to select a set of objects (records) based on:
Any combination of persistent objects mention above, yielding a list of subscriber Instance IDs to be included in a provisioning request.
Any combination of fields within the “transaction log”, yielding a set of records to be processed for transaction reporting.
Any combination of fields within the “event log”, yielding a set of records to be processed for transaction reporting.

Queries may be saved and retrieved for later use or re-use, and may be saved in the database in a predefined format. Methods may be provided for creating, modifying, and retrieving queries by name. A representative embodiment of the present invention may employ a proprietary easy-to-learn syntax, 2) use a simplified subset of SQL or 3) employ a combination of the two to address both flexibility and ease of use considerations.

A device management system in accordance with a representative embodiment of the present invention may comprise a device management client. A device management client in accordance with a representative embodiment of the present invention may comprise a significant extension over other device management clients. The device management client software of the present invention comprises a client agent, which interfaces to the device management server via a specific enhanced implementation of the OMA DM protocol. The client agent serves as the client side “agent” of the device management server, and may support SIM detection and “multi-step” job step management in close collaboration with the deployment broker described above. The major functional components of the device management client are as follows:
MVP Agent—OMA DM Version
OMA DM Client Service
Download Agent
Discovery Agent
Handoff Agent
Update Agent
Provisioning Agent

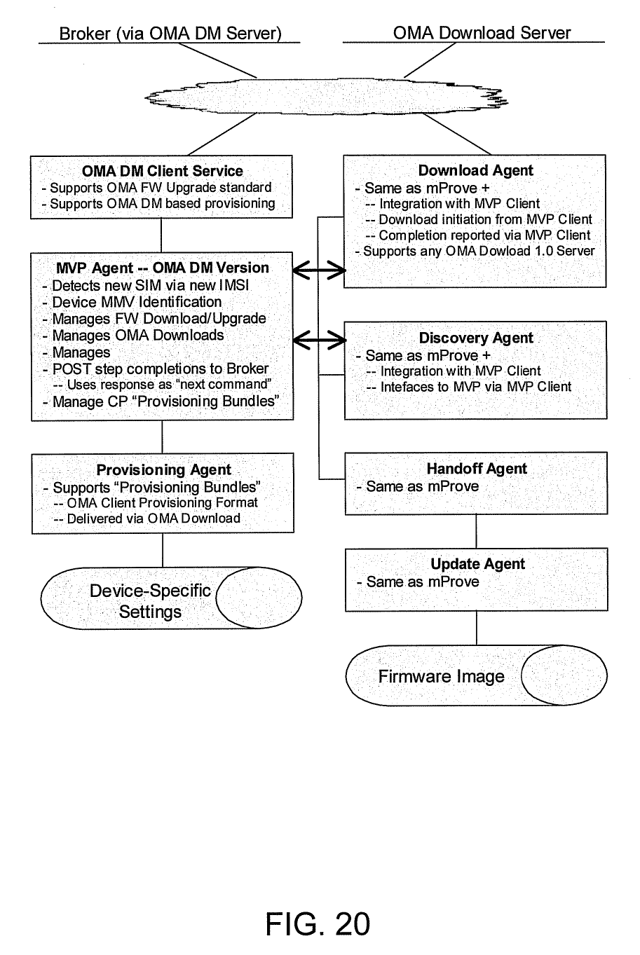

FIG. 20 is a block diagram that illustrates the principal functions of each component of an exemplary device client, and the flow among the principal components, in accordance with a representative embodiment of the present invention. The following is a description of a representative embodiment of a client agent compatible with the OMA DM protocol.

A key component of the device management client is the client agent, which is designed to interface device management-enabled handsets to a device management server in accordance with a representative embodiment of the present invention. The client agent discussed in this section employs the OMA DM protocol for initiating firmware upgrade, server to device user communication, and OMA DM data application service provisioning. A non-OMA DM-compatible version of the client agent is discussed below. The primary difference in function is the ability to set application parameters into the OMA DM tree when using the manufacturer's OMA DM implementation. The principal services of the client agent are:
1. Detection of a new SIM (IMSI)—The client agent may implement the client side of device management server new device detection by detecting that the mobile device has been powered up with a SIM specifying an IMSI that the client agent has not seen before. Upon such an event, the client agent may read the carrier's device management server connection settings and the subscriber's ID from a SIM file provided by the carrier. Using these connection settings, the client agent may then send an HTTP POST command to the device management server, announcing the new device/subscriber combination and providing the device management server with MMV information with the IMEI and subscriber ID.
2. User initiation of device upgrade—This allows the mobile device user to initiate an upgrade session from the mobile device, using either a menu item or the mobile device/handset browser.
3. Initiation of OMA DM Sessions—The client agent may provide the principal means of initiating new OMA DM sessions with the device management server. Such initiation may be in support of an OMA DM Notification from the device management server or upon completion of an OMA DM standard firmware upgrade, as dictated by the emerging standard.
4. Managing Firmware Upgrade—The client agent may provide firmware download and upgrade services, using the emerging OMA DM firmware upgrade standard. The client agent may manage all phases of the MMV identification process, the download of the firmware package, the installation of the firmware, and the reporting of status to the device management server through the initiation of an OMA DM reporting session. The client agent may use the device management client's OMA DM service to communicate with the device management server, but may maintain control over the each step of the process.
5. Managing Application and Data Downloads—The client agent may manage all software and data download requests and may report status upon the completion of each download back to the deployment broker. The client agent may interface with other mobile device/handset software to “install” downloads on the mobile device in accordance with the MIME type of the downloaded material.

During the execution of a multi-step job, the client agent may maintain communication with the deployment broker of the device management system by initiating a DM session and/or posting status reports to the device management server. The response from each such status post may be 1) to start an OMA DM session with a specified URL, 2) to begin an OMA download from a specified URL, 3) to end the current job.

When using an OEM implementation of OMA DM client services, the client agent of a representative embodiment of the present invention may have the responsibility of interfacing to OEM DM services, so that other system components can remain unaware of the OMA DM client services implementation.

A device management client in accordance with a representative embodiment of the present invention may comprise an OMA DM client service. The OMA DM client service may be provided with the device management client, or as part of the OEM mobile device/handset. The device management system-provided version of the OMA DM Client Service may be designed to be optimized to reflect its principal goal of supporting communication between the device management client and the device management server, not necessarily to be 100% OMA DM compliant. OMA DM compliance may be achieved, but OMA DM compliance is not a specific limitation of the present invention. A representative embodiment of the present invention may or may not be OMA DM compliant. A goal is to address the needs to support a sequence of OMA DM firmware upgrade, OMA data service provisioning, and initiating OMA Download operations.

The OMA DM features and commands involved in supporting firmware download include, for example:
Bootstrap, using the w7 WAP application characteristic which supports start session upon bootstrap.
Ability to support carrier or manufacturer mandated use of different types of bootstrap message security (e.g., USERPIN, NETWPIN, etc.)
HMAC/MD5, and encryption/HTTPS support.
Client and Server authentication (MD5)
Display Alert and Continue/Abort Alert for user notification/query
Alert 1224, for client notification after OMA DM firmware upgrade
Server and client initiated DM sessions
Add and Replace commands
Delete, including the deletion of interior nodes, deleting entire sub-tree
Get, including interior nodes and supporting both Struct and StructData
Exec as may be defined in the OMA DM firmware upgrade specification

In a representative embodiment of the present invention, an OMA DM client may or may not maintain actual DDF information on the device, and a device management server may or may not provide DDF information for new tree nodes. Additional tree elements may be added to the manufacturer's initial management tree without any DDF information as long as the manufacturer's DDF and access control lists (ACLs) of the original tree are not violated (e.g., by attempting to delete an OEM permanent node).

When an OMA DM compliant device management client is used, the DM client may be responsible for interfacing with OEM services for communicating OMA DM application data settings to the mobile device/handset by whatever means the OEM provides. When an OEM's version of the DM client is used, the OEM's DM client may have this responsibility, as it may control the OEM's management tree and its relationship with internal device settings.

A download agent in accordance with a representative embodiment of the present invention may interface with the client agent for both firmware and application downloads, and report status via the client agent. The client agent may assume responsibility for whatever handset “installation” might be required, based on a MIME type of a downloaded item.

A discovery agent in accordance with a representative embodiment of the present invention may be able to interface with the client agent, to gather MMV information for SIM detection and preparation for a firmware upgrade. In some representative embodiments of the present invention, the discovery agent may be a part of the client agent.

A handoff agent in accordance with a representative embodiment of the present invention may interface with the client agent. In some representative embodiments of the present invention, the handoff agent may be a part of the client agent.

An update agent in accordance with a representative embodiment of the present invention may interface with the client agent. In some representative embodiments of the present invention, the update agent may be a part of the client

A provisioning agent in accordance with a representative embodiment of the present invention may interface with the client agent. In some representative embodiments of the present invention, the provisioning agent may be a part of the client agent. In some representative embodiments of the present invention, the OMA DM protocol may prove to be unsuitable for general provisioning of data application settings, either due to insufficient support for OMA DM in the mobile device, or a lack of standardization of the application provisioning objects. Therefore, a representative embodiment of the present invention may implement its own settings provisioning service based on standardized OMA client provisioning “application characteristics”. Rather than using SMS push, OMA CP provisioning documents may be delivered to the device management client via OMA download, which the client agent may “install” through the use of the provisioning agent.

Once a client provisioning “package” has been delivered, the provisioning agent may be invoked to process the provisioning package and to update the appropriate data service and application settings in the mobile device. To update these settings, the provisioning agent may make use of device-specific “wrapper” functions, provided by the manufacturer of the mobile device, to access the appropriate values within the memory of the mobile device.

In a representative embodiment of the present invention, a complete set of provisioning parameters may be sent from the device management system service, but the provisioning agent may allow partial updates of mobile device settings. For example, the mobile device may have already been data provisioned and may already have enough information for browsing, bookmarks, and MMS. However, the email settings may be missing needed user ID and password values, so email may not yet be operational. The subscriber may visit the carrier's web site to update this information, which may trigger a new device management system request to (re-)provision the subscriber's mobile device. Since only the email settings have changed, only the application characteristics need to be sent to the client.

A representative embodiment of the present invention may read device parameters from the mobile device and send them to a device management server. In this manner, the device management server may be updated with setting changes made directly on the mobile device, 1) to update its data to avoid overwriting local changes, and 2) to be able to “back up” user settings, so that they can be reloaded on the same or different (new) device.

A representative embodiment of the present invention may also support a non-OMA DM compliant device management client. For some handset deployments, a version of the device management client may operate without the services of an OMA DM client implementation. The device management server may make requests for MMV information and may initiate downloads and firmware upgrades using custom SMS messages to the client agent. The SMS messages may contain the same server credentials as would be used in an OMA DM implementation, and the client agent's HTTP response may contain equivalent client credentials. Once communication is established, the client agent and device management server communication may be managed via HTTP request/response cycles, with the same overall method used for communicating step completion and getting the “next command” from the server.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claims is:

1. A system for managing firmware and configuration parameter update in memory of a plurality of mobile electronic device over a wireless communication network, the system comprising:
at least one server having resident thereon executable code for causing the server to communicate with entities external to the system, using a simple object abstraction protocol (SOAP) or application protocol interface (API); and
the at least one server also having resident thereon executable code for causing the server to communicate with at least one of the plurality of mobile electronic devices using an Open Mobile Alliance (OMA) device management (DM) protocol.

2. The system of claim 1, wherein the mobile electronic device comprises a mobile phone.

3. The system of claim 1, wherein the at least one server comprises two servers.

4. The system of claim 1, further comprising a customer self-care interface providing Internet access to customer support functions of the at least one server.

5. The system of claim 1, wherein the entities external to the system comprise a manufacturer of at least one of the plurality of mobile electronic devices.

6. The system of claim 1, wherein the at least one server schedules delivery of firmware updates to a selected subset of the plurality of mobile electronic devices based upon a user request submitted via an Internet browser.
